(19) United States
(12) Patent Application Publication
(10) Pub. No.: US 2013/0017989 A1
(43) Pub. Date: Jan. 17, 2013

(54) Builder Composition

(71) Applicants: James S. Dailey, Grosse Ile, MI (US); Thomas Bernard Gessner, Ypsilanti, MI (US); Kenneth Zack, Wyandotte, MI (US)

(72) Inventors: James S. Dailey, Grosse Ile, MI (US); Thomas Bernard Gessner, Ypsilanti, MI (US); Kenneth Zack, Wyandotte, MI (US)

(21) Appl. No.: 13/577,886

(22) PCT Filed: Feb. 9, 2011
(86) PCT No.: PCT/US11/24221

§ 371 Date: Oct. 2, 2012

Related U.S. Application Data
(60) Provisional application No. 61/302,845, filed on Feb. 9, 2010.

(51) Int. Cl. C11D 3/60

(52) U.S. Cl. 510/533

(57) ABSTRACT

A builder composition includes a chelating component A), a builder component B), a polymeric component C), and optionally an alkali component D) and/or a phosphorous-containing component E). The chelating component A) includes a1) methylglycine-N-N-diacetic acid (MGDA) and/or an alkali salt thereof, and/or a2) N,N-bis(carboxymethyl)-L-glutamate (GLDA) and/or an alkali salt thereof, and/or a3) ethylenediaminetetraacetic acid (EDTA) and/or an alkali salt thereof. The builder component B) includes b1) a metal silicate, and/or b2) a metal carbonate, and/or b3) a metal citrate. The polymeric component C) includes c1) an acrylic-maleic copolymer, and/or c2) polyacrylic acid (PAA).

### CROSS REFERENCE TO RELATED APPLICATIONS

This application claims the benefit of U.S. Provisional Patent Application Ser. No. 61/302,845, filed on Feb. 9, 2010, which is incorporated herewith by reference in its entirety including the Appendices thereof.

### FIELD OF THE INVENTION

The present invention generally relates to a builder composition. More specifically, the present invention relates to a builder composition including a chelating component, a builder component, a polymeric component, and optionally, an alkali component and/or a phosphorous-containing component.

### DESCRIPTION OF THE RELATED ART

Builder compositions are well known in the art, especially those used in industrial and institutional (I&I) cleaning formulations, in laundry formulations, in warewash formulations (e.g. automatic dishwasher detergents (ADDs)), and in formulations used to clean hard surfaces. The builder compositions, which typically include chelating agents and/or sequestering agents that bind cations (such as calcium and magnesium ions) in water, are usually added to the cleaning formulations to enhance their cleaning effectiveness to remove dirt, oil, grease, and the like, from surfaces in a variety of environments.

More specifically, builder compositions tend to, among other things, soften and buffer water and emulsify greases and oils. Builder compositions tend to soften water by deactivating hardness minerals through sequestration and/or precipitation. Builder compositions also typically provide a desirable level of alkalinity to the water, thereby increasing their cleaning effectiveness.

Particularly problematic stains to remove in laundry, warewash, and hard surface applications include “used motor oil,” baked on proteins, carbohydrates, starches, and the like. Oily and greasy films are also typically difficult to remove in warewash applications. Traditionally, the cleaning formulations that are the most efficacious in removing these types of stains include phosphate-containing components. Builder compositions that include phosphate are typically classified in the art as “high-performance” and tend to include trisodium phosphate and sodium tripolyphosphate (STPP). These high-performance builder compositions are thought to combine with the hardness minerals to form soluble complexes that can be removed with rinse water and also to sequester dissolved calcium, magnesium, and iron which can interfere with detergency.

However, when the high-performance builder compositions are used, the hardness minerals cannot readily combine with food soils. As a result, the hardness minerals and hardness mineral/food soil combinations tend to leave insoluble spots and/or films on dishware, glassware and tableware and do not allow for maximum cleaning to take place. Spotting is especially a concern with glassware, such as drinking glasses, since spotting is aesthetically displeasing, and calls into question cleanliness of the glassware. Filming, or “milkiness”, of glassware poses similar problems. In addition, the presence of insoluble spots on hard surfaces and in laundry applications is also a concern as general cleanliness is important for aesthetic and health reasons. As such, there remains an opportunity to develop improved builder compositions that provide excellent cleaning performance when applied to many different surfaces in many different applications.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is an X-Y scatter plot of sum percent clean actually observed as a function of sum percent clean predicted of one embodiment of the instant invention wherein the sum percent clean represents an approximate sum of the percent cleans set forth in FIGS. 2 through 8 below;

FIG. 2 is an X-Y scatter plot of percent clean actually observed as a function of percent clean predicted of one embodiment of the instant invention wherein the stain is dirty motor oil and the surface is a 65% polyester/35% cotton fabric and swatches of this stain and surface are commercially available from Testfabrics, Inc. of West Pittiston, Pa. as style number DMO 7436 WRL;

FIG. 3 is an X-Y scatter plot of percent clean actually observed as a function of percent clean predicted of one embodiment of the instant invention wherein the stain is dirty motor oil and the surface is a 100% cotton fabric and swatches of this stain and surface are commercially available from Testfabrics, Inc. as style number DMO 493;

FIG. 4 is an X-Y scatter plot of percent clean actually observed as a function of percent clean predicted of one embodiment of the instant invention wherein the stain is a mixture of mineral oil and carbon black, the surface is a 100% cotton fabric, and swatches of this stain and surface are commercially available from Scientific Services, Inc. of the United Kingdom as style number EMPA 106;

FIG. 5 is an X-Y scatter plot of percent clean actually observed as a function of percent clean predicted of one embodiment of the instant invention wherein the stain is a mixture of olive oil and carbon black, the surface is a 100% cotton fabric, and swatches of this stain and surface are commercially available from Scientific Services, Inc. of the United Kingdom as style number EMPA 104;

FIG. 6 is an X-Y scatter plot of percent clean actually observed as a function of percent clean predicted of one embodiment of the instant invention wherein the stain is lipstick, the surface is a 100% cotton fabric, and swatches of this stain and surface are commercially available from Scientific Services, Inc. of the United Kingdom as style number STC EMPA 141/2;

FIG. 7 is an X-Y scatter plot of percent clean actually observed as a function of percent clean predicted of one embodiment of the instant invention wherein the stain is makeup, the surface is a 100% cotton fabric, and swatches of this stain and surface are commercially available from Scientific Services, Inc. of the United Kingdom as style number STC EMPA 143/2;

FIG. 8 is an X-Y scatter plot of percent clean actually observed as a function of percent clean predicted of one embodiment of the instant invention wherein the stain is sebum, the surface is a 65% polyester/35% cotton fabric, and swatches of this stain and surface are commercially available from Scientific Services, Inc. of the United Kingdom as style Dust Sebum Soiled;

FIG. 9 is an X-Y scatter plot of percent clean actually observed as a function of percent clean predicted of one embodiment of the instant invention wherein 4×6 inch vinyl tile are stained and cleaned according to Federal Standard Test Method #536;

FIG. 10 is an X-Y scatter plot of cleaning actually observed as a function of cleaning predicted of one embodiment of the instant invention wherein the stain is baked-on egg and the surface is glazed ceramic;

FIG. 11 is an X-Y scatter plot of cleaning actually observed as a function of cleaning predicted of one embodiment of the instant invention wherein the stain is baked-on oatmeal gravy and the surface is glazed ceramic;

FIG. 12 is an X-Y scatter plot of filming actually observed as a function of filming predicted of one embodiment of the instant invention wherein the filming is determined using an Hobart AM-14 Commercial Dishwasher; and

FIG. 13 is a bar graph illustrating CaCO₃ dispersant capacity (mg/g) as a function of Builder Composition of various embodiments of this invention.

### SUMMARY OF THE INVENTION AND ADVANTAGES

The present invention provides a builder composition. The builder composition includes a chelating component A), a builder component B), a polymeric component C), and optionally an alkali component D) and/or a phosphorous-containing component E). The chelating component A) includes a1) methylglycine-N-N-diacetic acid (MGDA) and/or an alkali salt thereof, and/or a2) N,N-bis(carboxymethyl)-L-glutamate (GLDA) and/or an alkali salt thereof, and/or a3) ethylenediaminetetraacetic acid (EDTA) and/or an alkali salt thereof. The builder component B) includes b1) a metal silicate, and/or b2) a metal carbonate, and/or b3) a metal citrate. The polymeric component C) includes c1) an acrylic-maleic copolymer, and/or c2) polyacrylic acid (PAA).

The builder composition can be further described and/or customized according to various formulas evaluating efficiency of stain removal or reduction in filming on a variety of surfaces. In these formulas, “a1” is the weight fraction of the chelating component a1), “a2” is the weight fraction of the chelating component a2), “a3” is the weight fraction of the chelating component a3), “b1” is the weight fraction of the metal silicate b1), “b2” is the weight fraction of the metal carbonate b2), “b3” is the weight fraction of the metal citrate b3), “c1” is the weight fraction of the acrylic-maleic copolymer c1), “c2” is the weight fraction of the polyacrylic acid (PAA) c2), “D” is the weight fraction of optional alkali component D), and “E” is the weight fraction of optional phosphorus-containing component E). Also in these formulas, at least one of a1, a2, and a3 is greater than zero and less than 1.0, at least one of b1, b2, and b3 is greater than zero and less than 1.0, at least one of c1 and c2 is greater than zero and less than 1.0, D ranges from zero to less than 1.0, E ranges from zero to less than 1.0, and a1+a2+a3+b1+b2+b3+c1+c2+D+E=1.0. The present invention provides a unique combination of the chelating component A), the builder component B), and the polymeric component C). Generally, the unique combination of the aforementioned components imparts the builder composition with excellent cleaning characteristics and anti-scale forming benefits.

### DETAILED DESCRIPTION OF THE INVENTION

The instant invention provides a builder composition and a detergent composition that includes the builder composition. In various embodiments, one or both of the builder and/or detergent compositions is further defined as a warewash builder/detergent composition. In other embodiments, one or both of the builder and/or detergent compositions is further defined as a laundry builder/detergent composition. In still other embodiments, one or both of the builder and/or detergent compositions is further defined as a hard-surface (cleaning) builder/detergent composition. Of course, the instant invention is not limited to these types of compositions.

Typically, warewash builder/detergent compositions are used to clean and/or sanitize dishware, cookware, pots, pans, cutlery, dishes, cup, glasses, bowls, saucers, and the like. In one embodiment, warewashing refers to cleaning and/or sanitizing food-contact surfaces of food service/preparation equipment and utensils. In addition, laundry builder/detergent compositions are typically used to clean and/or sanitize textiles, garments, clothing, fabrics, yarns, and the like. Furthermore, hard-surfaces builder/detergent compositions are typically used to clean and/or sanitize non-porous, semi-porous, or partially porous substrates in commercial, residential, agricultural, veterinary, hospital, hospitality, industrial, and similar settings. Additional non-limiting warewash, laundry, and hard-surface applications and descriptions are set forth below.

In addition to the builder and detergent compositions, the instant invention also provides methods of forming both the builder and detergent compositions and methods of washing/laundering/cleaning/sanitizing and/or disinfecting surfaces using the builder and detergent compositions. In one embodiment, the surface is a hard surface. Non-limiting examples of hard surfaces are those found in kitchens and bathrooms, on walls and floors, in showers and bathtubs, on countertops and cabinets, on exterior surfaces such as on driveways, patios, siding, decking, and the like, on vehicles, and on marble, glass, metal, vinyl, fiberglass, ceramic, granite, concrete, acrylic, Formica®, Silestone®, Conan®, and laminated surfaces. In another embodiment, the surface is a soft surface. Examples of soft surfaces include, but are not limited to, laundry, fabrics, textiles, and carpets. In various embodiments, the surface is further defined as cloth, fabric, and/or yarn and may include, but is not limited to, polyester, cotton, nylon, wool, silk, and combinations thereof. In one embodiment, the substrate is cotton. In another embodiment, the substrate is a fabric comprising polyester and cotton. In still another embodiment, the surface is a fabric that includes 65% by weight of polyester and 35% by weight of cotton. In yet another embodiment, the surface includes a commercial uniform, e.g., coveralls, overalls, medical scrubs, prison uniforms, etc.

It is contemplated that the surface may be laundered, cleaned with water, heated, steamed, scrubbed, and/or scoured, and the like. The surface may be dry cleaned and or stain treated. The surface may be wet, dry, or include portions that are wet and other portions that are dry. The surface may be heated, cooled, or at room temperature. The surface may be porous or non-porous and may absorb or repel water.

The surface may be soiled with stains including, but not limited to, greasy stains, inorganic stains, organic stains, petroleum based stains, egg stains, oatmeal stains, protein stains, carbohydrate stains, starch stains, used motor oil stains, stains associated with bodily functions, stains resulting from sebum, body oils, animal fats, soap scums, stains resulting from scale/lime deposits, rust, corrosion and oxidation, minerals, and water spots, stains resulting from ink, mold, yeast, blood, grass, mustard, coffee, tea, alcohol, bacteria and animal waste, vomit, stains from both gasoline and diesel engines, from axle grease, gum, paint, tar, lipstick and make-up, paraffins, cooking oils, adhesive residue, and combinations thereof. In one embodiment, the stain is used motor oil which typically includes motor oil previously used in gasoline or diesel engines. In another embodiment, the stain is sebum. In still another embodiment, the stain is makeup, such as makeup sold commercially as a beauty product. In yet another embodiment, the stain is lipstick. Fabrics stained with lipstick and/or makeup are commercially available from Scientific Services, Inc. of the United Kingdom as style numbers STC EMPA 141/2 and STC EMPA 143/2, respectively. In another embodiment, the stain is a combination of carbon black/olive oil. Fabrics stained with the olive oil and carbon black are commercially available from Scientific Services, Inc. under the trade name of EMPA 104. The stain may be a combination of mineral oil and carbon black. Fabrics stained with the mineral oil and carbon black and are commercially available from Scientific Services, Inc. under the trade name of EMPA 106.

The builder and detergent compositions typically have excellent cleaning properties. Some of these properties include one or more of the following: tying-up/inactivating hardness minerals, such as calcium and magnesium; reducing surface tension of water to allow water to penetrate and loosen soil, such as food soil; emulsifying and/or solubilizing soils in water, such as greasy or oily soils; suspending and/or dispersing removed soils in water; saponifying oily/fatty soils, enzymatically digesting protein-based soils; removing proteinaceous and starchy soils; suppressing foam caused by protein soils, such as eggs and milk; lowering surface and interfacial tensions of water; protecting china patterns and metals from the corrosive effects of heat and water; and neutralizing acidic soils.

In various embodiments, the builder and/or detergent compositions have one or more excellent cleaning properties that may include one or more of the properties described immediately below. Detergency is a cleaning property that includes the ability to break the bond between soil and a surface. Penetration and wetting are cleaning properties which allow water to surround soil particles that would otherwise repel the water. Emulsification is a cleaning property that includes the ability to break up oil based soils into small droplets that can be dispersed thoroughly. Solubilizing is a cleaning property that dissolves soil such that the soil is no longer a solid particle. Dispersing is a cleaning property which leads to spreading small soil particles throughout a solution (e.g. wash water) to prevent the soil particles from sticking to objects such as dishwasher racks, dishwasher walls, or back onto a cleaned surface (e.g. dishes, glasses and tableware).

The builder and/or detergent compositions can be especially useful for helping water to sheet off surfaces, thus minimizing water spots and filming on the same. Films are typically formed on tableware and glassware upon evaporation of water containing solids. Solids in wash water can originate from soil load and/or soils present on dishes, glassware, etc. Typical soils include proteinaceous, fatty and starch-based soils. Water hardness contributes to the presence of solids typically in the form of insoluble calcium and magnesium salts. Water temperature can also affect the cleaning performance of the builder and/or detergent compositions, with increased temperature typically increasing cleaning performance of the builder and/or detergent compositions.

The builder and/or detergent compositions are typically liquid, but may be liquid/gels, gels, or solids. The builder and/or detergent compositions can be supplied to consumers in various ways. Typically, the builder and/or detergent compositions are supplied to consumers in bottles or similar containers. In other embodiments, the builder and/or detergent compositions may be retained within conventional packets, sachets or pouches. However, the builder and/or detergent compositions may be in free-flowing forms, such as in liquid forms in bottles, for ease of use.

In various embodiments, the builder composition has a viscosity of less than 1,000, of from 100 to 1000, of from 200 to 900, of from 300 to 800, of from 400 to 700, or of from 500 to 600, cP at 25° C. Alternatively, the builder composition may have a higher viscosity or may be a solid or a gel. In other embodiments, the detergent composition has a viscosity of at least about 500, alternatively from about 1,000 to about 15,000, of from about 1,000 to about 10,000, of from about 4,000 to about 8,000, or of from about 5,000 to about 8,000, cP at 25° C. The viscosities of the builder and/or detergent compositions may be determined by any method known in the art. For example, the viscosities may be measured using a Brookfield viscometer, a Shell cup, a Zahn cup, a parallel-plate rheometer, etc.

Those skilled in the art appreciate the gels are generally higher in viscosity relative to liquids, and/or gels have a thixotropic or non-Newtonian character relative to liquids. As such, when the builder and/or detergent composition is a liquid/gel or a gel, it typically has a viscosity the same as described and exemplified immediately above, or a viscosity that is higher or lower than described and exemplified immediately above.

For ease of use, the builder and/or detergent compositions can be placed into a reservoir of a dishwasher by pouring into the reservoir which may or may not include a cover. Alternatively, the builder and/or detergent compositions may be poured in to the dishwasher directly. Alternatively, the builder and/or detergent compositions may placed into an external dosing unit, such as a dosing unit of an institutional dishwasher. When the builder and/or detergent compositions are in the form of a gel, it may be especially useful when the reservoir is on a door of the dishwasher, such that the gel will cling to the door thereby increasing contact with water during use of the dishwasher. It is to be appreciated that the present invention is not limited to any particular use of the builder and/or detergent compositions. For example, the builder and/or detergent compositions of the present invention are useful for a variety of applications, such as in both residential/household and institutional dishwashing applications, residential/household and institutional laundry applications, residential/household and institutional hard surface cleaning, etc.

The builder composition includes a (A) chelating component. The (A) chelating component may include a1) methylglycine-N-N-diacetic acid (MGDA) and/or an alkali salt thereof, and/or a2) N,N-bis(carboxymethyl)-L-glutamate (GLDA) and/or an alkali salt thereof, and/or a3) ethylenediaminetetraacetic acid (EDTA) and/or an alkali salt thereof. It is to be appreciated that the (A) chelating component may include one or more of a1), a2), and a3), and may include combinations thereof. The (A) chelating component may also include one or more additional compounds such as N,N,N-nitrilotriacetic acid (NTA).

MGDA is also commonly referred to in the art as methylglycine diacetate whereas GLDA is also commonly referred to in the art as glutamic acid diacetate. For a1), the alkali salt is typically a sodium salt of MGDA, such as Na₃.MGDA, which is also referred to in the art as methylglycine diacetate, trisodium salt. For a2), the alkali salt is typically a sodium salt of GLDA, such as tetrasodium L-glutamic acid, N,N-diacetic acid or Na₄.GLDA. However, the alkali salt may include any alkali or alkaline earth metal and is not particularly limited.

As used hereinafter, the acronym MGDA is generally meant to include either MGDA, or an alkali salt of MGDA, (e.g. Na₃.MGDA), or mixtures thereof. Likewise, the acronym GLDA is generally meant to include either GLDA, or an alkali salt of GLDA. It is to be appreciated that the (A) chelating component can include a combination of MGDA and GLDA.

Typically, the (A) chelating component is aqueous, such that the (A) chelating component includes water and one or more of a1), a2), and a3), e.g. water and MGDA. In various embodiments, the (A) chelating component is aqueous and MGDA is employed such that the MGDA is present in the (A) chelating component in amounts of from about 35 to about 95, of from about 35 to about 85, or of about 35 to about 45, or of about 40, parts by weight, each based on 100 parts by weight of the (A) chelating component. In other embodiments, the (A) chelating component is aqueous and GLDA is present in similar amounts as described above for MGDA. It is to be appreciated that the (A) chelating component may also be in the form of a powder or a gel.

The (A) chelating component is useful for inactivating hardness minerals and/or metallic ions in water, such as water encountered in conventional residential, commercial, industrial and institutional dishwashers. Hardness of water is generally imparted to the water by minerals, such as calcium and magnesium. Other metallic ions include dissolved metals, such as iron and manganese.

Typically, MGDA and GLDA inactivate hardness minerals (e.g. calcium and magnesium) and iron and manganese without precipitation. Water softening without precipitation, i.e., by sequestration, distinguishes MGDA and GLDA from other compounds such as sodium carbonate, which generally soften by precipitation of the hardness minerals. MGDA and GLDA generally combine with hardness minerals and hold them in solution such that the hardness minerals cannot combine with (food) soils. In addition, neither the hardness minerals themselves nor the hardness mineral/soil combination typically leave insoluble spots or film on dishes and the like.

Without being bound or limited by any particular theory, it is believed that the low molecular weight of MGDA imparts MGDA with greater chelating/sequestering efficiency relative to other chelating agents or components, such as GLDA. Those skilled in the art can appreciate that MGDA and GLDA are both generally classified as aminocarboxylates. It is to be appreciated that the builder composition is not limited solely to the use of MGDA and/or GLDA, and may include one or more chelating agents in addition to MGDA and/or GLDA.

Non-limiting examples of suitable (A) chelating components are commercially available from BASF Corporation of Florham Park, N.J., under the trade name TRILON® M, such as TRILON® M liquid, TRILON® A, and TRILON® B. Further non-limiting examples of suitable (A) chelating components are commercially available from AkzoNobel of Chicago, Ill., under the trade name DISSOLVINE® GL. Other non-limiting examples of suitable (A) chelating components are described in U.S. Pat. No. 5,786,313 to Schneider et al. and in U.S. Pat. App. Pub. No. 2009/0105114 to Stolte et al., the disclosures of which are incorporated herein by reference in their entirety to the extent that the disclosures do not conflict with the general scope of the present invention described herein.

In various embodiments, the (A) chelating component is present in amounts of from 0 to 95, of from 10 to 90, of from 20 to 80, of from 30 to 60, of from 40 to 50, of from 5 to 90, of from 15 to 85, of from 25 to 75, of from 35 to 65, of from 45 to 55, of from 5 to 10, or of from 5 to 20, parts by weight per 100 parts by weight of the builder composition. In one embodiment, the (A) chelating component is present in an amount of from 10 to 15 parts by weight per 100 parts by weight of the builder composition. Of course, it is to be understood that the amount of the (A) chelating component is not limited to those amounts described above and may include any amount or range of amounts within or between those amounts described above. The (A) chelating component may also be present in any amount calculated according to one or more of the formulas described in detail below.

In other embodiments, a1) is present in amounts of from 0.1 to 95, of from 10 to 90, of from 20 to 80, of from 30 to 60, of from 40 to 50, of from 5 to 90, of from 15 to 85, of from 25 to 75, of from 35 to 65, of from 45 to 55, of from 5 to 10, or of from 5 to 20, parts by weight per 100 parts by weight of the builder composition.

In one embodiment, a1) is present in an amount of from 10 to 15 parts by weight per 100 parts by weight of the builder composition. In still other embodiments, a2) and/or a3) is present in one or more of the amounts described above relative to a1). Of course, it is to be understood that the amounts of a1), a2) and/or a3) are not limited to those amounts described above and may include any amount or range of amounts within or between those amounts described above. Alternatively, a1), a2), and/or a3) may also be present in any amount calculated according to one or more of the formulas described in detail below.

The builder composition also includes (B) a builder component. The (B) builder component may include a b1) metal silicate, and/or a b2) metal carbonate, and/or a b3) metal citrate. The metal may be any alkali metal or alkaline earth metal. Typically, the metal is sodium (Na) or potassium (K). However, the metal is not limited and may alternatively include a transition metal.

In one embodiment, the (B) builder component includes one or more of b1) sodium silicate (also known as sodium metasilicate), and/or b2) sodium carbonate, and/or b3) sodium citrate. Examples of additional non-limiting compounds that can be utilized include sodium bicarbonate, sodium aluminosilicate, and combinations thereof. Specific examples of suitable sodium metasilicates, for purposes of the present invention, are commercially available from PQ Corporation of Malvern, Pa., under the name of METSO®, such as METSO® Pentabead 20 and METSO® Beads 2048.

The metal carbonate may be further defined as sodium carbonate, which is also commonly referred to in the art as “soda ash,” especially when in an anhydrous form, or as “washing soda” when in a hydrated/crystalline form. Because metal carbonates are generally strong alkaline salts, the metal carbonates are useful as (B) builder components and also as sources of OIT ions. The metal carbonate provides alkaline cleaning power and also typically softens water by precipitating the hardness minerals out of solution. Sodium carbonate is a precipitating builder and tends to soften water by converting hardness minerals to insoluble forms in contrast to softening by sequestration, i.e., without precipitation. Typically, precipitating builders soften or inactivate hardness salts by removing mainly calcium as insoluble compounds.

The metal carbonate is also useful for breaking down and helping to remove proteinaceous and starchy soils from surfaces, such as those described above. The metal carbonate is thought to have a synergy with the (A) chelating component, as described further below. Suitable grades of metal carbonates are commercially available from a variety of suppliers.

The metal citrate is typically a metal (e.g. Na or K) salt of citric acid. As such, the metal citrate may include some amount of citric acid itself, such as trace amounts of citric acid. It is to be appreciated that citric acid may also be used as an additional component in the builder and/or detergent compositions.

Typically, the metal citrate sequesters hardness minerals. The metal citrate is also useful as a builder and as an alkaline buffer. The metal citrate is thought to have a synergy with the (A) chelating component, as described further below. Suitable grades of metal citrates are commercially available from a variety of suppliers.

In various embodiments, the (B) builder component is present in amounts of from 0.1 to 95, of from 10 to 90, of from 20 to 80, of from 30 to 60, of from 40 to 50, of from 5 to 90, of from 15 to 85, of from 25 to 75, of from 35 to 65, of from 45 to 55, of from 15 to 25, of from 30 to 35, or of from 30 to 60, parts by weight per 100 parts by weight of the builder composition. In one embodiment, the (B) builder component is present in an amount of from 20 to 60 parts by weight per 100 parts by weight of the builder composition. Of course, it is to be understood that the amount of the (B) builder component is not limited to those amounts described above and may include any amount or range of amounts within or between those amounts described above. The (B) builder component may also be present in any amount calculated according to one or more of the formulas described in detail below.

In other embodiments, b1) is present in amounts of from 0 to 95, of from 10 to 90, of from 20 to 80, of from 30 to 60, of from 40 to 50, of from 5 to 90, of from 15 to 85, of from 25 to 75, of from 35 to 65, of from 45 to 55, of from 15 to 25, of from 30 to 35, or of from 30 to 60, parts by weight per 100 parts by weight of the builder composition. In one embodiment, b1) is present in an amount of from 20 to 60 parts by weight per 100 parts by weight of the builder composition. In still other embodiments, b2) and/or b3) are present in one or more of the amounts described above relative to b1). Of course, it is to be understood that the amounts of b1), b2) and/or b3) are not limited to those amounts described above and may include any amount or range of amounts within or between those amounts described above. Alternatively, one or more of the b1), b2), and/or b3) may be present in any amount calculated according to one or more of the formulas described in detail below.

The builder composition also includes a (C) polymeric component. The (C) polymeric component may include c1) an acrylic-maleic copolymer, and/or c2) polyacrylic acid (PAA). The acrylic-maleic copolymer is a copolymer of acrylic acid and maleic acid and/or polyacrylic acid (PAA). The (C) polymeric component typically keeps particles of soil that have been removed from wares in a dispersed or suspended state such that the particles are more readily removed from the dishwasher when the wash water is pumped out. The (C) polymeric component can also be useful as a thickener. Examples of suitable (C) polymeric components are commercially available from BASF Corporation under the trade name SOKALAN®, such as SOKALAN° PA 30 CL.

In various embodiments, the (C) polymeric component is present in amounts of from 0.1 to 95, of from 10 to 90, of from 20 to 80, of from 30 to 60, of from 40 to 50, of from 5 to 90, of from 15 to 85, of from 25 to 75, of from 35 to 65, of from 45 to 55, of from 30 to 35, of from 50 to 60, or of from 15 to 55, parts by weight per 100 parts by weight of the builder composition. In one embodiment, the (C) polymeric component is present in an amount of from 15 to 60 parts by weight per 100 parts by weight of the builder composition. Of course, it is to be understood that the amount of the (C) polymeric component is not limited to those amounts described above and may include any amount or range of amounts within or between those amounts described above. The (C) polymeric component may also be present in any amount calculated according to one or more of the formulas described in detail below.

In other embodiments, c1) is present in amounts of from 0 to 95, of from 10 to 90, of from 20 to 80, of from 30 to 60, of from 40 to 50, of from 5 to 90, of from 15 to 85, of from 25 to 75, of from 35 to 65, of from 45 to 55, of from 30 to 35, of from 50 to 60, or of from 15 to 55, parts by weight per 100 parts by weight of the builder composition. In one embodiment, c1) is present in an amount of from 15 to 60 parts by weight per 100 parts by weight of the builder composition. In still other embodiments, c2) is present in one or more of the amounts described above relative to c1). Of course, it is to be understood that the amounts of c1) and c2) are not limited to those amounts described above and may include any amount or range of amounts within or between those amounts described above. Alternatively, one or both of c1) and/or c2) may also be present in any amount calculated according to one or more of the formulas described in detail below.

The builder composition may optionally include (D) an alkali component. The (D) alkali component typically includes a metal hydroxide, such as lithium hydroxide, sodium hydroxide, potassium hydroxide, magnesium hydroxide, calcium hydroxide, strontium hydroxide, etc., in solid and/or liquid form. However, it is also contemplated that another and/or an additional metal hydroxide and/or alkali compound may be utilized. Additional suitable (D) alkali compounds include, but are not limited to, ammonia, nitrogen containing bases, bicarbonates, and the like. In various embodiments, the (D) alkali component is present in an amount of from 0 to 50, 5 to 45, 10 to 40, 15 to 35, 20 to 30, 25 to 35, 40 to 45, or of from 1 to 45, parts by weight based on 100 parts by weight of the builder and/or detergent compositions. Of course, it is to be understood that the amounts of (D) are not limited to those amounts described above and may include any amount or range of amounts within or between those amounts described above. The optional (D) alkali component may also be present in any amount calculated according to one or more of the formulas described in detail below.

The builder and/or detergent compositions may also include the (E) phosphorous-containing component. The (E) phosphorous-containing component may include any known in the art including, but not limited to, trisodium phosphate and sodium tripolyphosphate (STPP). In various embodiments, the (E) phosphorous-containing component is present in amounts of from 0 to 25, of from 5 to 20, or of from 10 to 15, parts by weight per 100 parts by weight of the builder composition. Of course, it is to be understood that the amount of the (E) phosphorous-containing component is not limited to those amounts described above and may include any amount or range of amounts within or between those amounts described above. The optional (E) phosphorus-containing component may also be present in any amount calculated according to one or more of the formulas described in detail below.

Alternatively, the builder and/or detergent compositions may include less than 5, 4, 3, 2, 1, 0.5, 0.25, 0.1, or 0.05 parts by weight of the optional (D) alkali component and/or the optional (E) phosphorous-containing component, per 100 parts by weight of the builder and/or detergent compositions. In other embodiments, the builder and/or detergent compositions are entirely free of the optional (D) alkali component and/or the optional (E) phosphorous-containing component.

The builder and/or detergent compositions may also include water. Controlling the amount of water present within the builder and/or detergent compositions is useful for controlling viscosity of the builder and/or detergent compositions, which is described further below. In various embodiments, water is present in the builder and/or detergent compositions in an amount of from 10 to 90, of from 20 to 80, of from 30 to 70, of from 40 to 60, of from 50 to 90, of from 50 to 60, or of from 60 to 80, parts by weight, each based on 100 parts by weight of the builder and/or detergent compositions. It is to be appreciated that viscosity can be controlled by other means in addition or alternate to use of water, such as by the use of one or more thickeners.

Synergistic Relationship between (A) through (E):

In various embodiments, the builder and/or detergent compositions are used to clean a variety of stains from different surfaces and/or to reduce filming on the surfaces. Without intending to be limited by any particular theory, it is believed that a synergy exists between the total amounts of the (A) chelating component, (B) builder component, (C) polymeric component, and optionally the (D) alkali component and the (E) phosphorous-containing component. In other words, various amounts of the different components (A) through (E) can be customized to maximize cleaning efficiency and performance depending on what stain is to be removed and/or whether reduction in filming is desired. The synergy and the customization of various embodiments of this invention are represented below in a series of non-limiting equations.

In each of the following equations, “a1” is the weight fraction of the chelating component a1), “a2” is the weight fraction of the chelating component a2), “a3” is the weight fraction of the chelating component a3), “b1” is the weight fraction of the metal silicate b1), “b2” is the weight fraction of the metal carbonate b2), “b3” is the weight fraction of the metal citrate b3), “c1” is the weight fraction of the acrylic-maleic copolymer c1), “c2” is the weight fraction of the PAA c2), “D” is the weight fraction of optional alkali component (D), and “E” is the weight fraction of optional phosphorus-containing component (E).

Moreover, in these non-limiting equations, at least one of a1, a2, and a3 is greater than zero and less than 1.0; at least one of b1, b2, and b3 is greater than zero and less than 1.0; at least one of c1 and c2 is greater than zero and less than 1.0; D ranges from zero to less than 1.0; E ranges from zero to less than 1.0; and a1+a2+a3+b1+b2+b3+c1+c2+D+E=about 1.0.

### First Non-Limiting Equation:

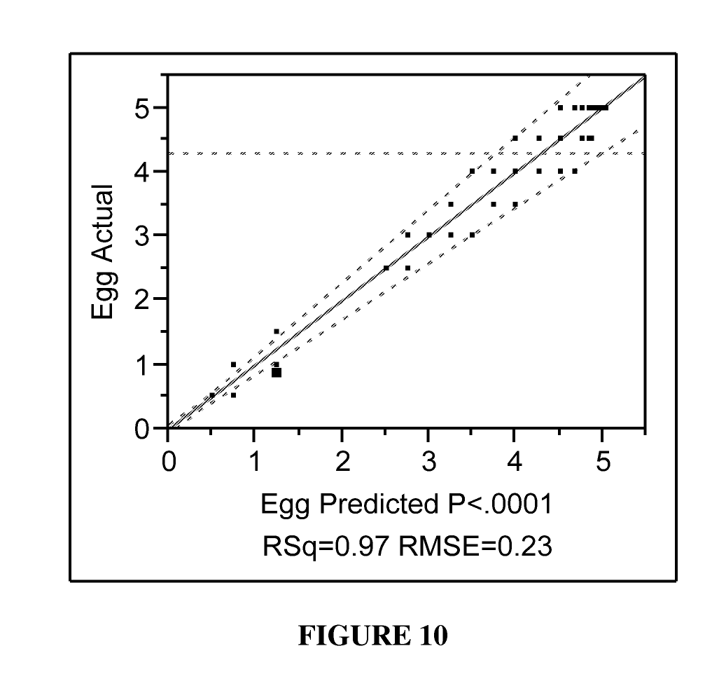

In a first non-limiting equation, one embodiment of this invention is evaluated relative to protein removal performance (P) on a ceramic substrate. Results are set forth in FIG. 10. In various embodiments, P ranges from 0 to 5, 1 to 4, 1 to 3, 1 to 2, 2 to 5, 2 to 4, 2 to 3, 3 to 5, or 3 to 4. Typically, P is greater than 0 and less than or equal to 3.5. It is also contemplated that P may be any number, fraction, or range of number or fractions between 0 and 5. It is to be understood that each of the values set forth below is approximately numerically rounded to two decimal points.

In this evaluation, a lower number is better relative to a higher number. In other words, 5.0 is considered to be worse than 4.5, 4.5 is considered to be worse than 4.0 and so on. One way to articulate the performance numbers is to use a five point scale comprising five levels of performance. The five point scale includes excellent (e.g. 1.0), very good (e.g. 2.0), good (e.g. 3.0), fair (e.g. 4.0), and poor (e.g. 5.0). It is to be appreciated that similar scales could also be used, such as a ten point scale.

In this first non-limiting equation:

P=(5*b1)+(4.5*D)+(4.99*E)+(4.99*b2)+(4.99*a1)+(4.67*a2)+(5.04*b3)+(5.04*c1)+(5.04*c2)+(4.86*a3)+[−4.97*(b1*E)]+[−0.97*(b1*b2)]+[—8.97*(b1*a1)]+[−8.35*(b1*a2)]+[−1.08*(b1*b3)]+[−3.08*(b1*c1)]+[−4.08*(b1*c2)]+[−7.72(b1*a3)]+[−16.97*(D*E)]+[−8.97*(D*b2)]+[−15.97*(D*a1)]+[−13.35*(D*a2)]+[−5.08*(D*b3)]+[−8.08*(D*c1)]+[−6.08*(D*c2)]+[−13.72*(D*a3)]+[−1.95*(e*b2)]+[−1.95*(b2*a1)]+[−3.32*(b2*a2)]+[−2.06*(b2*c2)]+[−1.70*(b2*a3)]+[−1.32*(a1*a2)]+[−1.70*(a1*a3)]+[0.93*(a2*a3)].

In one embodiment, an egg is scrambled and approximately 1 gram of the scrambled egg is brushed onto a glazed ceramic saucer. The saucer is then placed in a convection oven at 187° C. for 30 min. The saucer is then allowed to cool to room temperature before use. Subsequently, the builder composition is applied to remove the egg. Typically, the saucer is washed in a Hobart AM-14 commercial dishwasher, as described in greater detail below in the Examples. The saucer is then visually evaluated for cleanliness. A clean saucer would have a rating of 0 and the baked saucers would have a rating of 5. Of course, the instant invention is not limited to use with egg stains as any protein stain may be substituted.

### Second Non-Limiting Equation:

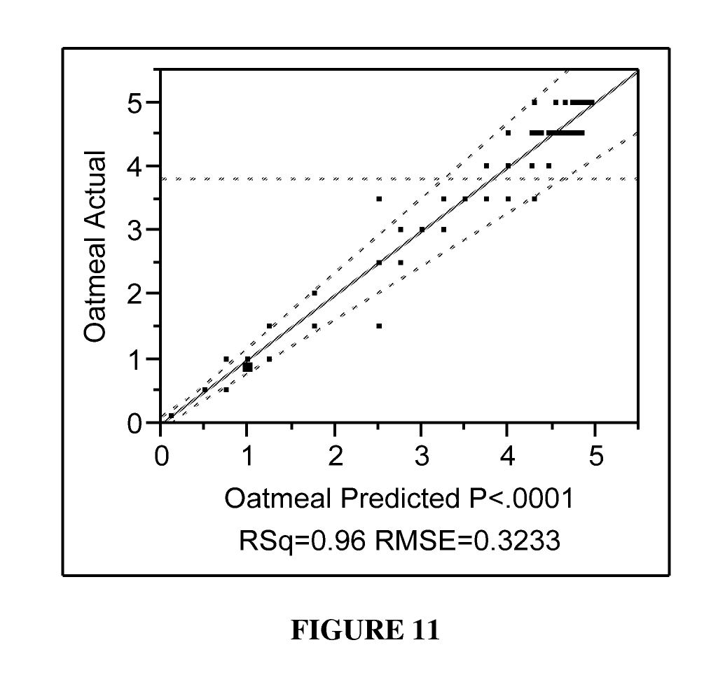

In a second non-limiting equation, one embodiment of this invention is evaluated relative to carbohydrate removal performance (Z) on a ceramic substrate. Results are set forth in FIG. 11. In various embodiments, Z ranges from 0 to 5, 1 to 4, 1 to 3, 1 to 2, 2 to 5, 2 to 4, 2 to 3, 3 to 5, or 3 to 4. Typically, Z is greater than 0 and less than or equal to 3.5. It is also contemplated that Z may be any number, fraction, or range of number or fractions between 0 and 5. It is to be understood that each of the values set forth below is approximately numerically rounded to two decimal points.

In this evaluation, a lower number is better relative to a higher number. In other words, 5.0 is considered to be worse than 4.5, 4.5 is considered to be worse than 4.0 and so on. One way to articulate the performance numbers is to use a five point scale comprising five levels of performance. The five point scale includes excellent (e.g. 1.0), very good (e.g. 2.0), good (e.g. 3.0), fair (e.g. 4.0), and poor (e.g. 5.0). It is to be appreciated that similar scales could also be used, such as a ten point scale.

In this second non-limiting equation:

Z=(4.75*b1)+(4*D)+(4.85*E)+(4.54*b2)+(4.83*a1)+(4.30*a2)+(4.94*b3)+(4.38*c1)+(4.36*c2)+(4.65*a3)+[−2.5*(b1*D)]+[−5.2*(b1*E)]+[−2.57*(b1*b2)]+[−3.14*(b1*a1)]+[−7.09*(b1*a2)]+[−4.38*(b1*b3)]+[−2.26*(b1*c1)]+[−8.23*(b1*c2)]+[−5.82*(b1*a3)]+[−15.71*(D*E)]+[−14.08*(D*b2)]+[−17.25*(D*a1)]+[−14.59*(D*a2)]+[−7.88*(D*b3)]+[−11.76*(D*c1)]+[−9.73*(D*c2)]+[−13.31*(D*a3)]+[−1.78*(e*b2)]+[−2.67*(b2*a2)]+[−3.24*(a1*a2)]+[−1.97*(a1*a3)]+[−1.47*(a2*b3)]+[−1.36*(a2*c1)]+[−5.91*(a2*a3)]

In one embodiment, 110 g of H₂O is heated to a boil. The heat is then shut down and 10 g of ground Quaker® oatmeal is added to the water and allowed to mix for 5 minutes. Subsequently, 1 g of powdered gravy is added to the oatmeal to form a solution. The solution is then allowed to cool to room temperature. Then, approximately 1 gram of the solution is brushed onto a glazed ceramic saucer. The saucer is then placed in a convection oven at 187° C. for 30 min. The saucer is then allowed to cool to room temperature before use. Subsequently, the builder composition is applied to remove the oatmeal gravy. Typically, the saucer is washed in a Hobart AM-14 commercial dishwasher, as described in greater detail below in the Examples. The saucer is then visually evaluated for cleanliness. A clean saucer would have a rating of 0 and the baked saucers would have a rating of 5. Of course, the instant invention is not limited to use with oatmeal stains as any carbohydrate stain may be substituted.

In each of the two aforementioned non-limiting equations, the ceramic surface may be traditional ceramic, may be earthenware, stoneware, porcelain, or combinations thereof. The ceramic surface may be glazed. As is known in the art, a glaze is a layer or coating of a vitreous substance which has been fired to fuse to the ceramic for color, decorating, strengthening or waterproofing purposes. Glazes generally include silica to form glass, in combination with a mixture of metal oxides such as sodium, potassium and calcium which act as a flux and allow the glaze to melt at a particular temperature. Alumina (usually from added clay) may be used stiffen the glaze and prevent it from running off the ceramic. Colorants such as iron oxide, copper carbonate or cobalt carbonate, and sometimes opacifiers such as tin oxide or zirconium oxide may also be used. In various embodiments, the ceramic surface may be further defined as washware including, but not limited to, cups, bowls, saucers, plates, and the like.

### Third Non-Limiting Equation:

In a third non-limiting equation, one embodiment of this invention is evaluated relative to filming reduction performance (F) on a glass substrate. In one embodiment, a glass beaker is used to determine filming reduction performance (F). More specifically, a glass beaker is added to the Hobart AM-14 commercial dishwasher along with one or more of the glazed ceramic saucers that include one or more of the stains described above. After the saucers are cleaned, an amount of filming on the glass surface is visually evaluated and assigned a rating of 0-10.

In this evaluation, a lower number is better relative to a higher number. In other words, 5.0 is considered to be worse than 4.5, 4.5 is considered to be worse than 4.0 and so on. In various embodiments, F ranges from 0 to 10, 1 to 9, 1 to 8, 1 to 7, 1 to 6, 1 to 5, 1 to 4, 1 to 3, 1 to 2, 2 to 5, 2 to 4, 2 to 3, 3 to 5, or 3 to 4. Typically, F is greater than 0 and less than or equal to 4.0. It is also contemplated that F may be any number, fraction, or range of number or fractions between 0 and 10. It is to be understood that each of the values set forth below is approximately numerically rounded to two decimal points.

In this third non-limiting equation:

F=(3.82*b1)+(9.91*D)+(1.74*E)+(4.26*b2)+(−0.08*a1)+(0.09*a2)+(−0.17*b3)+(1.39*c1)+(0.18*c2)+(−0.26*a3)+[−9.45*(b1*D)]+[−11.12*(b1*E)]+[−6.47*(b1*a1)]+[−3.81*(b1*a2)]+[−6.42*(b1*c1)]+[−3.12*(b1*a3)]+[−19.29*(D*E)]+[−10.32*(D*b2)]+[−7.65*(D*a1)]+[−10.59*(D*c1)]+[−2.17*(D*c2)]+[−1.99*(e*b2)]+[−3.31*(e*a1)]+[−3.65*(e*a2)]+[−4.26*(e*c1)]+[−3.84*(e*c2)]+[3.32*(b2*a2)]+[3.13*(b2*c2)]+[8.01*(b2*a3)]+[10.69*(a1*a3)]+[12.35*(a2*a3)]+[5.56*(b3*c1)]+[2.87*(b3*a3)]+[−3.14*(c1*c2)]+[−2.26*(c1*a3)]

Fourth Non-Limiting Equation:

In a fourth non-limiting equation, one embodiment of this invention is evaluated relative to a sum of stain removal (S) of the builder composition relative to many different stains and surfaces. The stain and surfaces may include one or more of the stains described below relative to equations 5 through 11. Without intending to be limited by any particular theory, it is believed that this fourth non-limiting equation represents the sum of the results of the fifth through eleventh non-limiting equations described in detail below.

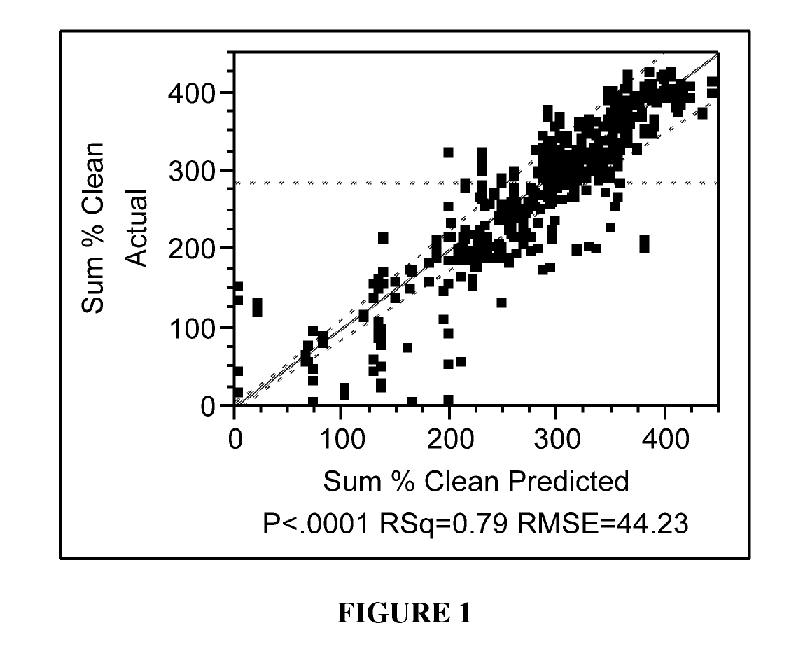

In this fourth non-limiting equation, variables representing water having a hardness (H) of Ca²⁺ as CaCO₃ in parts per million in the water and having a temperature (T) in degrees Fahrenheit are included. In various embodiments, S is at least 175, 200, 225, or 250. It is also contemplated that S may be any number, fraction, or range of number or fractions between 175 and 400. It is to be understood that each of the values set forth below is approximately numerically rounded to two decimal points. Results are set forth in FIG. 1.

In this fourth non-limiting equation:

S=(206.59*a1)+(63.09*b1)+(−72.04*D)+(165.46*E)+(184.84*c1)+(69.54*b3)+(214.93*a2)+[−128.32*(a1*D)]+[316.97*(b1*D)]+[124.84*(b1*E)]+[172.47*(b1*c1)]+[118.04*(b1*a2)]+[643.71*(D*E)]+[622.44*(D*c1)]+[−447.42*(D*b1)]+[−294.34(D*a2)]+[−131.51*(e*c1)]+(−0.69*H)+(2.05*T)

Fifth Non-Limiting Equation:

In a fifth non-limiting equation, one embodiment of this invention is evaluated relative to dirty motor oil removal performance (M) on a fabric including polyester and cotton (e.g. 65% polyester/35% cotton), as measured in “Percent Clean”. The precise method used to determine “Percent Clean” is described in greater detail below in the Examples. The dirty motor oil typically includes oil previously used in gas and/or diesel engines. In this equation, variables representing water having a hardness (H) of Ca²⁺ as CaCO₃ in parts per million in the water and having a temperature (T) in degrees Fahrenheit are included.

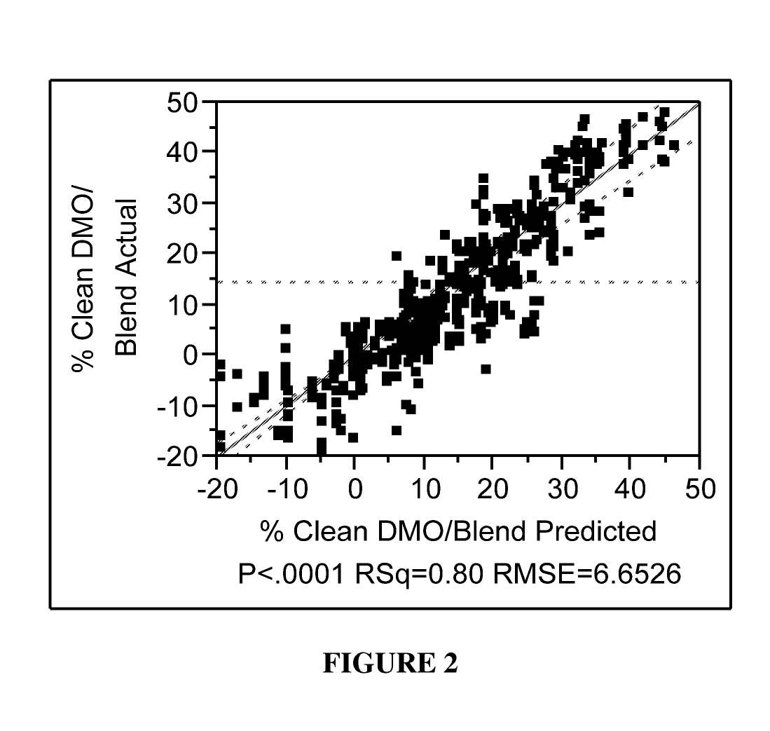

Relative to percent clean, higher values are considered “more clean” than lower values. Said differently, a higher percent clean value indicates that more of the stain was removed than a lower percent clean value. In various embodiments, M is at least 5 and ranges up to 100. Typically, M is greater than 5 and ranges up to about 50. It is also contemplated that M may be any number, fraction, or range of number or fractions between 5 and 100. It is to be understood that each of the values set forth below is approximately numerically rounded to two decimal points. Results are set forth in FIG. 2.

In this fifth non-limiting equation:

M=(−0.15*a1)+(−28.74*b1)+(−38.02*D)+(−10.15*E)+(−10.52*c1)+(−26.79*b3)+(5.74*a2)+[−35.37*(a1*D)]+[14.11*(a1*a2)]+[14.95*(b1*D)]+[12.79*(b1*E)]+[21.08*(b1*c1)]+[39.04*(D*E)]+[36.17*(D*c1)]+[−50.71*(D*b3)]+[−72.59(D*a2)]+[−13.63*(e*c1)]+[22.63*(e*a2)]+(−0.10*H)+(0.36*T)

Sixth Non-Limiting Equation:

In a sixth non-limiting equation, one embodiment of this invention is evaluated relative to dirty motor oil removal performance (O) on a fabric including cotton (e.g. 100% cotton), as measured in “Percent Clean”. The precise method used to determine “Percent Clean” is described in greater detail below in the Examples. The dirty motor oil typically includes oil previously used in gas and/or diesel engines. In this equation, variables representing water having a hardness (H) of Ca²⁺ as CaCO₃ in parts per million in the water and having a temperature (T) in degrees Fahrenheit are included.

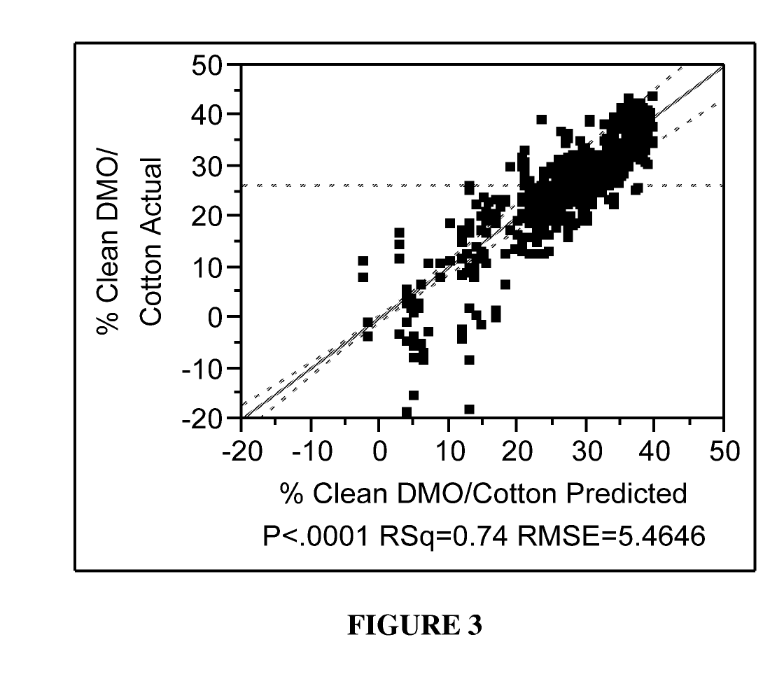

Relative to percent clean, higher values are considered “more clean” than lower values. Said differently, a higher percent clean value indicates that more of the stain was removed than a lower percent clean value. In various embodiments, O is at least 15 and ranges up to 100. Typically, M is greater than 15 and ranges up to about 50. It is also contemplated that O may be any number, fraction, or range of number or fractions between 15 and 100. It is to be understood that each of the values set forth below is approximately numerically rounded to two decimal points. Results are set forth in FIG. 3.

In this sixth non-limiting equation:

O=(−2.81*a1)+(−9.19*b1)+(−27.12*D)+(−2.76*E)+(0.46*c1)+(−6.43*b3)+(−0.49*a2)+[−32.19*(a1*D)]+[21.69*(b1*D)]+[16.44*(D*E)]+[39.13*(D*c1)]+[−58.80*(D*b3)]+[−64.78*(D*a2)]+[11.51*(c1*b3)]+(−0.01*H)+(0.27*T)

Seventh Non-Limiting Equation:

In a seventh non-limiting equation, one embodiment of this invention is evaluated relative to removal performance (Y) of a mixture of mineral oil and carbon black on a fabric including cotton (e.g. 100% cotton), as measured in “Percent Clean”. The precise method used to determine “Percent Clean” is described in greater detail below in the Examples. Swatches of this stain and surface are commercially available from Scientific Services, Inc. of the United Kingdom under the trade name of EMPA 106. In this equation, variables representing water having a hardness (H) of Ca²⁺ as CaCO₃ in parts per million in the water and having a temperature (T) in degrees Fahrenheit are included.

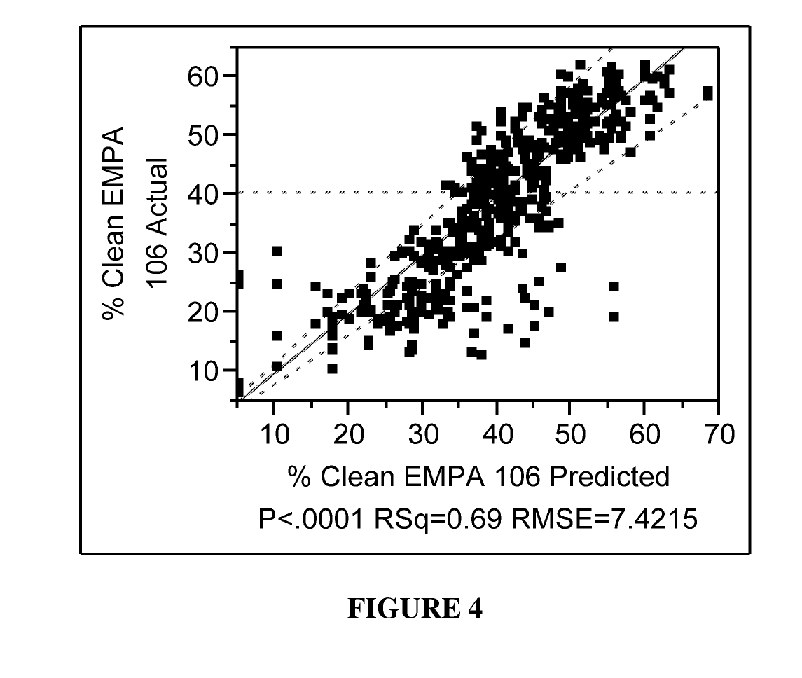

Relative to percent clean, higher values are considered “more clean” than lower values. Said differently, a higher percent clean value indicates that more of the stain was removed than a lower percent clean value. In various embodiments, Y is at least 15 and ranges up to 100. Typically, Y is greater than 15 and ranges up to about 50. It is also contemplated that Y may be any number, fraction, or range of number or fractions between 15 and 100. It is to be understood that each of the values set forth below is approximately numerically rounded to two decimal points. Results are set forth in FIG. 4.

In this seventh non-limiting equation:

Y=(25.92*a1)+(−0.61*b1)+(−5.71*D)+(18.02*E)+(22.77*c1)+(−1.99*b3)+(17.85*a2)+[31.53*(a1*D)]+[−14.90*(a1*E)]+[−13.43*(a1*c1)]+[38.64*(b1*D)]+[16.02*(b1*E)]+[28.29*(b1*c1)]+[26.86*(b1*a2)]+[109.19*(D*E)]+[71.73(D*c1)]+[30.89*(D*b3)]+[46.29*(D*a2)]+[−29.99*(e*c1)]+[−19.91*(c1*a2)]+[26.32*(b3*a2)]+(−0.13*H)+(0.35*T)

Eighth Non-Limiting Equation:

In an eighth non-limiting equation, one embodiment of this invention is evaluated relative to lipstick removal performance (L) on a fabric including cotton (e.g. 100% cotton), as measured in “Percent Clean”. The precise method used to determine “Percent Clean” is described in greater detail below in the Examples. Swatches of this stain and surface are commercially available from Scientific Services, Inc. of the United Kingdom as style number STC EMPA 141/2. In this equation, variables representing water having a hardness (H) of Ca²⁺ as CaCO₃ in parts per million in the water and having a temperature (T) in degrees Fahrenheit are included.

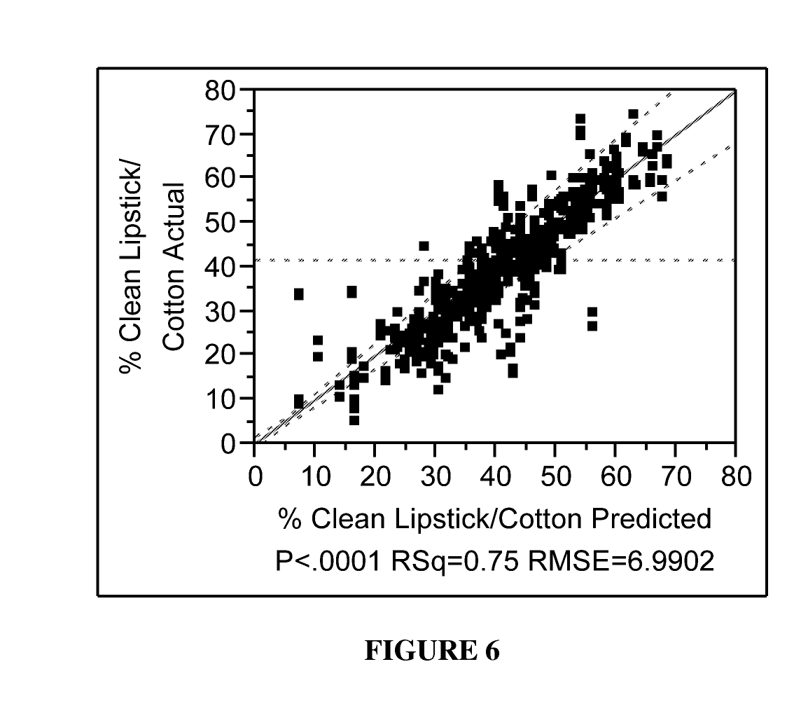

Relative to percent clean, higher values are considered “more clean” than lower values. Said differently, a higher percent clean value indicates that more of the stain was removed than a lower percent clean value. In various embodiments, L is at least 30 and ranges up to 100. Typically, Y is greater than 30 and ranges up to about 80. It is also contemplated that Y may be any number, fraction, or range of number or fractions between 30 and 100. It is to be understood that each of the values set forth below is approximately numerically rounded to two decimal points. Results are set forth in FIG. 6.

In this eighth non-limiting equation:

L=(5.65*a1)+(−16.06*b1)+(−24.74*D)+(−1.59*E)+(−3.98*c1)+(−13.83*b3)+(13.59*a2)+[18.30*(a1*D)]+[−11.83*(a1*E)]+[−11.31*(a1*c1)]+[34.54*(b1*D)]+[28.34*(b1*c1)]+[−14.13*(b1*b3)]+[100.72*(D*E)]+[104.74*(D*c1)]+[−42.48(D*b3)]+[−26.48*(e*c1)]+[−17.59*(e*b3)]+[15.59*(c1*a2)]+[−16.49*(b3*a2)]+(−0.09*H)+(0.45*T)

Ninth Non-Limiting Equation:

In a ninth non-limiting equation, one embodiment of this invention is evaluated relative to makeup removal performance (K) on a fabric including cotton (e.g. 100% cotton), as measured in “Percent Clean”. The precise method used to determine “Percent Clean” is described in greater detail below in the Examples. Swatches of this stain and surface are commercially available from Scientific Services, Inc. of the United Kingdom as style number STC EMPA 143/2. In this equation, variables representing water having a hardness (H) of Ca²⁺ as CaCO₃ in parts per million in the water and having a temperature (T) in degrees Fahrenheit are included.

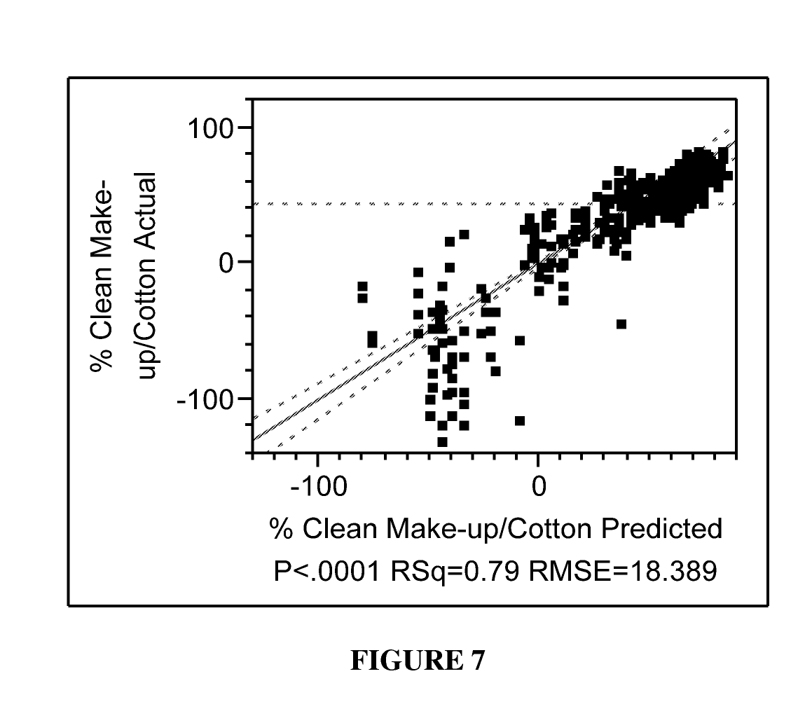

Relative to percent clean, higher values are considered “more clean” than lower values. Said differently, a higher percent clean value indicates that more of the stain was removed than a lower percent clean value. In various embodiments, K is at least 10 and ranges up to 100. Typically, K is greater than 10 and ranges up to about 85. It is also contemplated that K may be any number, fraction, or range of number or fractions between 10 and 100. It is to be understood that each of the values set forth below is approximately numerically rounded to two decimal points. Results are set forth in FIG. 7.

In this ninth non-limiting equation:

K=(52.42*a1)+(25.43*b1)+(−59.44*D)+(48.42*E)+(56.75*c1)+(41.43*b3)+(67.07*a2)+[−125.14*(a1*D)]+[27.50*(a1*E)]+[26.36*(a1*c1)]+[118.40*(b1*D)]+[55.11*(b1*E)]+[42.39*(b1*c1)]+[67.28*(b1*a2)]+[202.82*(D*E)]+[235.57(D*c1)]+[−294.51*(D*b3)]+[−191.52*(D*a2)]+(−0.06*H)+(0.17*T)

Tenth Non-Limiting Equation:

In a tenth non-limiting equation, one embodiment of this invention is evaluated relative to sebum removal performance (U) on a fabric including polyester and cotton (e.g. 65% polyester/35% cotton), as measured in “Percent Clean”. The precise method used to determine “Percent Clean” is described in greater detail below in the Examples. Swatches of this stain and surface are commercially available from Scientific Services, Inc. of the United Kingdom as style Dust Sebum Soiled. In this equation, variables representing water having a hardness (H) of Ca²⁺ as CaCO₃ in parts per million in the water and having a temperature (T) in degrees Fahrenheit are included.

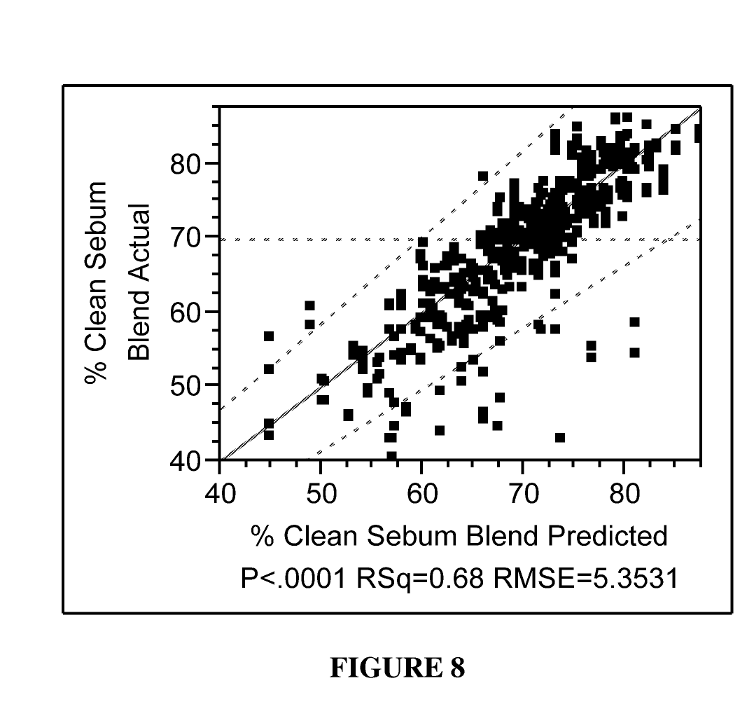

Relative to percent clean, higher values are considered “more clean” than lower values. Said differently, a higher percent clean value indicates that more of the stain was removed than a lower percent clean value. In various embodiments, U is at least 60 and ranges up to 100. Typically, U is greater than 60 and ranges up to about 95. It is also contemplated that U may be any number, fraction, or range of number or fractions between 60 and 100. It is to be understood that each of the values set forth below is approximately numerically rounded to two decimal points. Results are set forth in FIG. 8.

In this tenth non-limiting equation:

U=(79.12*a1)+(70.65*b1)+(57.54*D)+(72.74*E)+(73.71*c1)+(62.05*b3)+(73.48*a2)+[−9.10*(a1*D)]+[−10.87*(a1*E)]+[−9.61*(a1*a2)]+[36.14*(b1*D)]+[21.95*(b1*E)]+[22.45*(b1*c1)]+[73.88*(D*E)]+[60.85*(D*c1)]+[−41.41(D*b3)]+[−41.50*(D*a2)]+[−21.80*(e*c1)]+(−0.12*H)+(0.14*T)

Eleventh Non-Limiting Equation:

In an eleventh non-limiting equation, one embodiment of this invention is evaluated relative to stain removal (Q) of olive oil and carbon black on a fabric including cotton (e.g. 100% cotton), as measured in “Percent Clean”. The precise method used to determine “Percent Clean” is described in greater detail below in the Examples. Swatches of this stain and surface are commercially available from Scientific Services, Inc. of the United Kingdom under the trade name of EMPA 104.

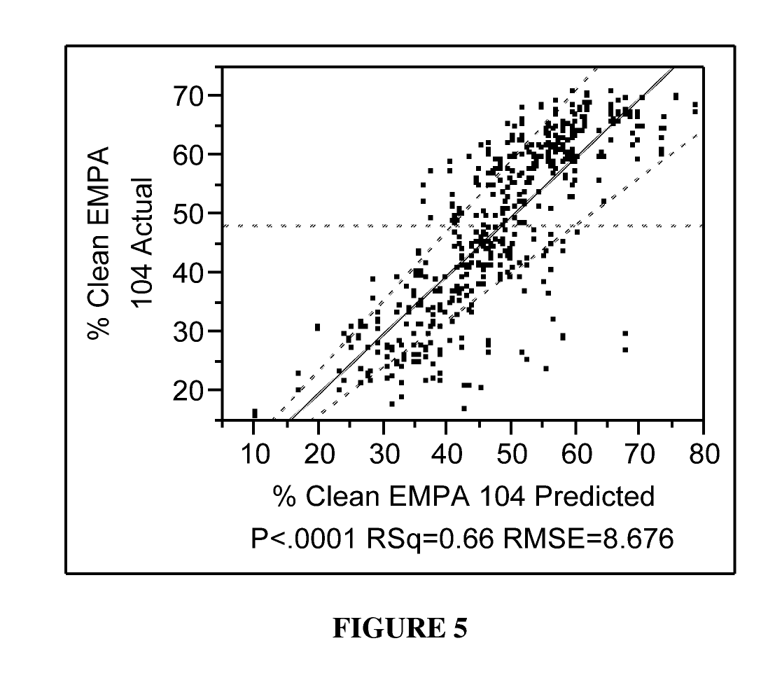

Relative to percent clean, higher values are considered “more clean” than lower values. Said differently, a higher percent clean value indicates that more of the stain was removed than a lower percent clean value. In various embodiments, Q is at least 40 and ranges up to 100. Typically, Q is greater than 40 and ranges up to about 75. It is also contemplated that Q may be any number, fraction, or range of number or fractions between 40 and 100. It is to be understood that each of the values set forth below is approximately numerically rounded to two decimal points. Results are set forth in FIG. 5.

In this eleventh non-limiting equation:

Q=(46.83*a1)+(17.91*b1)+(24.51*D)+(40.17*E)+(43.34*c1)+(13.71*b3)+(35.65*a2)+[15.82*(a1*b1)]+[22.98*(a1*D)]+[−14.75*(a1*E)]+[−19.07*(a1*a2)]+[57.30*(b3*D)]+[29.81*(b3*E)]+[42.79*(b1*c1)]+[28.85*(b1*a2)]+[102.43(D*E)]+[79.99*(D*c1)]+[25.44*(D*a2)]+[−31.07*(E*c1)]+[−14.47*(c1*a2)]+[24.72*(b3*a2)]+(−0.19*H)+(0.33*T)

Twelfth Non-Limiting Equation:

In a twelfth non-limiting equation, one embodiment of this invention is evaluated relative to stain removal performance (X) on vinyl tiles. More specifically, an oil/iron oxide stain mixture formed according to Federal Standard Test Method #536 is applied to various 4×6 inch vinyl tiles as described above. Then, samples of various builder compositions of this invention are diluted to 3 wt % in hard water (250 ppm Ca/Mg 2/1) to form diluted compositions. The diluted compositions are then applied to the stain tiles according to Federal Standard Test Method #536 to determine percent clean. More specifically, an X-rite reflectometer is used to determine an amount of the stain removed. This value is then converted to percent clean.

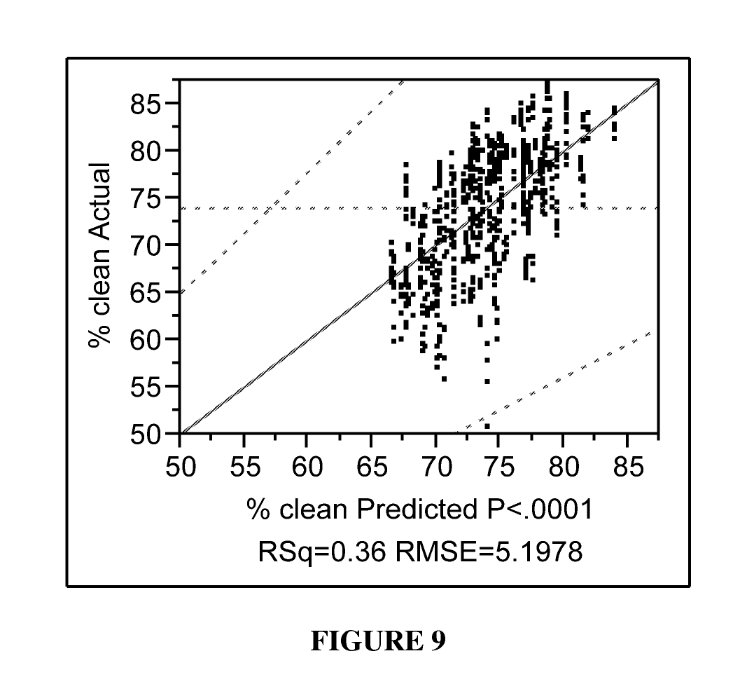

In various embodiments, X is at least 65 and ranges up to 100. Typically, X is greater than 60 and ranges up to about 85. It is also contemplated that X may be any number, fraction, or range of number or fractions between 65 and 100. It is to be understood that each of the values set forth below is approximately numerically rounded to two decimal points. Results are set forth in FIG. 9.

In this twelfth non-limiting equation:

X=(76.08*E)+(66.71*D)+(63.14*b1)+(74.86*a1)+(75.55*b3)+(71.46*c1)+(78.99*a3)+(78.26*a2)+[18.44*(e*D)]+[16.96*(e*b1)]+[28.24*(e*a1)]+[−13.31*(e*b3)]+[14.40*(e*a3)]+[28.95*(e*a2)]+[8.03*(D*a1)]+[38.69(D*c1)]+[18.62*(b1*a1)]+[−13.09*(b1*b3)]+[9.55*(b1*c1)]+[−11.28*(b1*a3)]+[19.40*(a1*c1)]+[−18.27*(a1*a3)]+[−23.22*(b3*c1)]+[−34.14*(b3*a3)]+[−22.77*(c1*a3)]

Additives That Can Be Included in the Builder and/or Detergent Compositions:

Referring back to the builder and/or detergent compositions, one or both of these compositions may include one or more additives such as supplemental builder components, bleaches, enzymes, solvents, salts, graying inhibitors, soil release polymers, color transfer inhibitors, foam inhibitors, complexing agents, optical brighteners, fragrances, fillers, inorganic extenders, formulation auxiliaries, solubility improvers, opacifiers, dyes, corrosion inhibitors, peroxide stabilizers, electrolytes, soaps, detergents, acids such as phosphoric acid, amidosulfonic acid, citric acid, lactic acid, acetic acid, peracids, and trichloroisocyanuric acid, solvents such as ethylene glycol, 2-butoxyethanol, butyldiglycol, alkyl glycol ethers, and isopropanol, chelating agents such as perfumes, oils, oxidizing agents such as perborates, dichloroisocyanurates, enzymes, interface-active ethyleneoxy adducts, surfactants, and combinations thereof.

Suitable non-ionic surfactants include, but are not limited to, alkylphenol alkoxylates, alkyl polyglucosides, hydroxyalkyl polyglucosides, N-alkylglucamides, alkylene oxide block copolymers, polyhydroxy and polyalkoxy fatty acid derivatives, and combinations thereof. The alkylphenol alkoxylates may include alkylphenol ethoxylates having C₆-C₁₄ alkyl chains and from 5 to 30 moles of alkylene oxide added to the alkyl chains. The alkyl polyglucosides and/or hydroxyalkyl polyglucosides may have from 8 to 22 carbon atoms in an alkyl chain and have from 1 to 20 glucoside units. The N-alkylglucamides may have C₆-C₂₂ alkyl chains and may be formed from acylation of reductively aminated sugars with corresponding long-chain carboxylic acid derivatives. Further, the alkylene oxide block copolymers may include block copolymers of ethylene oxide, propylene oxide and/or butylene oxide. Still further, the polyhydroxy and/or polyalkoxy fatty acid derivatives may include polyhydroxy fatty acid amides, N-alkoxy- and/or N-aryloxy-polyhydroxy fatty acid amides, fatty acid amide ethoxylates, and also fatty acid alkanolamide alkoxylates. In various embodiments, the non-ionic surfactant is present in the builder and/or detergent compositions in an amount of from 1 to 20% by weight. In another embodiment, a mixture of anionic and non-ionic surfactants is present in a weight ratio from 95:5 to 20:80 and more typically from 80:20 to 50:50.

Suitable cationic surfactants include, but are not limited to, interface-active compounds including ammonium groups such as alkyldimethylammonium halides and compounds having the chemical formula RR′R″R″′N+X— wherein R, R′, R″, and R″′ are independently selected from the group of alkyl groups, aryl groups, alkylalkoxy groups, arylalkoxy groups, hydroxyalkyl(alkoxy) groups, and hydroxyaryl(alkoxy) groups and wherein X is an anion. Suitable ampholytic surfactants include, but are not limited to, aliphatic derivatives of secondary and/or tertiary amines which include an anionic group, alkyldimethylamine oxides, alkyl- and/or alkoxymethylamine oxides, and combinations thereof. Other suitable surfactants may include, but is not limited to, aliphatic and/or aromatic alkoxylated alcohols, LAS (linear alkyl benzene sulfonates), paraffin sulfonates, FAS (fatty alcohol sulfates), FAES (fatty alcohol ethersulfates), methylethylene glycols, butylethylene glycols, pentylethylene glycols, hexylethylene glycols, butylpropylene glycols, trimethylolpropane ethoxylates, glycerol ethoxylates, pentaerythritol ethoxylates, alkoxylates of bisphenol A, alkoxylates of 4-methylhexanol and 5-methyl-2-propylheptanol, polyethylene glycols, and combinations thereof. Additional non-limiting surfactants and other additives are described in U.S. Pat. Nos. 7,504,373 and 7,503,333, and U.S. Provisional Patent Application No. 61/302,785 and a concurrently filed PCT Application, both related to Docket Number: 10062/PF-61435 and entitled “LIQUID DETERGENT COMPOSITION.” The disclosures of each of these documents are expressly incorporated by reference in their entirety to the extent that the disclosures do not conflict with the general scope of the present invention described herein.

The builder and/or detergent compositions may be free of an anionic surfactant or may include an anionic surfactant. While LAS surfactants tend to be the most commonly used anionic surfactants, other anionic surfactants include alkane sulfonate, alkyl ethoxylate sulfate, alkyl glyceryl sulfonate, alkyl sulfate, and alpha olefin sulfonate. In various embodiments, the builder and/or detergent compositions include the anionic surfactant amounts of from about 15 to approaching zero (0), more typically from about 10 to approaching 0, yet more typically from about 5.0 to approaching 0, and even more typically from about 1.0 to approaching 0, parts by weight, each based on 100 parts by weight of the builder and/or detergent compositions. In certain embodiments, the builder and/or detergent compositions completely exclude the anionic surfactant.

Suitable graying inhibitors include, but are not limited to, polyesters of polyethylene oxides with ethylene glycol and/or propylene glycol and aromatic dicarboxylic acids or aromatic and aliphatic dicarboxylic acids, polyesters of polyethylene oxides terminally capped at one end with di- and/or polyhydric alcohols or dicarboxylic acids, and combinations thereof. Suitable soil release polymers include, but are not limited to, amphiphilic graft polymers or copolymers of vinyl esters and/or acrylic esters onto polyalkylene oxides or modified celluloses, such as methylcellulose, hydroxypropylcellulose, and carboxymethylcellulose, and combinations thereof. In one embodiment, the builder and/or detergent compositions include the soil release polymer present in an amount of from 0.3 to 1.5% by weight. Suitable color transfer inhibitors include, but are not limited to, color transfer inhibitors, for example homopolymers and copolymers of vinylpyrrolidone, of vinylimidazole, of vinyloxazolidone and of 4-vinylpyridine N-oxide having number average molecular weights of from 15,000 to 100,000 g/mol. In one embodiment, the builder and/or detergent compositions include the color transfer inhibitor present in an amount of from 0.05 to 5% by weight. Suitable foam inhibitors include, but are not limited to, organopolysiloxanes, silica, paraffins, waxes, microcrystalline waxes, and combinations thereof.

The additive may be a bleach. The bleach may include, but is not limited to, alkali metal perborates, alkali metal carbonate perhydrates, peracids, and combinations thereof. Suitable examples of peracids include, but are not limited to, peracetic acid, C₁-C₁₂ percarboxylic acids, C₈-C₁₆ dipercarboxylic acids, imidopercaproic acids, aryldipercaproic acids, linear and branched octane-, nonane-, decane- or dodecane-monoperacids, decane- and dodecane-diperacid, mono- and di-perphthalic acids, isophthalic acids and terephthalic acids, phthalimidopercaproic acid, terephthaloyldipercaproic acid, polymeric peracids, salts thereof, and combinations thereof. The bleach may be present in the builder and/or detergent compositions in any amount. In one embodiment, the bleach is present in the builder and/or detergent compositions in an amount of from 0.5 to 30% by weight.

In various embodiments, the builder and/or detergent compositions are free of a chlorine-containing component. Examples of components containing chlorine include chlorine bleaches, which generally belong to a group of strong oxidizing agents, all of which have one or more chlorine atoms in their molecule. Specific examples of chlorine bleaches used in the art include chlorinated isocyanurates, chlorinated trisodium phosphate, hypochlorite, and sodium hypochlorite.

By free of a chlorine-containing component, it is generally meant that the builder and/or detergent compositions are free of a purposefully added component including chlorine, such as the addition of chlorine bleach, e.g. sodium hypochlorite. In some embodiments, the builder and/or detergent compositions include some trace amount of chlorine, such as a trace amount of chlorine present in one or more of the components.

In various embodiments, the builder and/or detergent compositions include chlorine in an amount of from about 0.50 to approaching zero (0), of from about 0.25 to approaching 0, and of from about 0.10 to approaching 0, parts by weight, each based on 100 parts by weight of the builder and/or detergent compositions. In one embodiment, the builder and/or detergent compositions completely exclude chlorine.

In some embodiments, the builder and/or detergent compositions are free of a bleach component. While chlorine bleaches tend to be commonly used bleach components, other bleaches include non-chlorine bleaches, such as peroxygen compounds, which release active oxygen in wash water. Further examples of non-chlorine bleaches include perborates/sodium perborates, potassium monopersulfates, sodium percarbonates, hydrogen peroxides, and organic peracids. In various embodiments, the builder and/or detergent compositions includes the bleach component in an amount of from about 15 to approaching zero (0), of from about 10 to approaching 0, of from about 5.0 to approaching 0, or of from about 1.0 to approaching 0, parts by weight, each based on 100 parts by weight of the builder and/or detergent compositions. In certain embodiments, the builder and/or detergent compositions completely exclude the bleach component.

Referring back to the additives, the additive may be a bleach activator present in an amount of from 0.1 to 15% by weight. The bleach activator may include, but is not limited to, polyacylated sugars, e.g., pentaacetylglucose, acyloxybenzenesulfonic acids and alkali metal and alkaline earth metal salts thereof, e.g., sodium p-isononanoyloxybenzenesulfonate and sodium p-benzoyloxybenzenesulfonate, N,N-diacetylated and N,N,N′,N′-tetraacylated amines, e.g., N,N,N′,N′-tetraacetylmethylenediamine and -ethylenediamine (TAED), N,Ndiacetylaniline, N,N-diacetyl-p-toluidine or 1,3-diacylated hydantoins, such as 1,3-diacetyl-5,5-dimethylhydantoin, N-alkyl-N-sulfonylcarboxamides, e.g., N-methyl-N-mesylacetamide and N-methyl-N-mesylbenzamide, N-acylated cyclic hydrazides, acylated triazoles and urazoles, e.g., monoacetylmaleic acid hydrazide, O,N,N-trisubstituted hydroxylamines, e.g., O-benzoyl-N,N-succinylhydroxylamine, O-acetyl-N,N-succinylhydroxylamine and O, N,N-triacetylhydroxylamine, N,N′-diacylsulfurylamides, e.g., N,N′-dimethyl-N,N′-diacetylsulfurylamide and N,N′-diethyl-N,N′-dipropionylsulfurylamide, triacyl cyanurates, e.g., triacetyl cyanurate and tribenzoyl cyanurate, carboxylic anhydrides, e.g., benzoic acid anhydride, m-chlorobenzoic anhydride and phthalic anhydride, 1,3-diacyl-4,5-diacyloxyimidazolines, e.g., 1,3-diacetyl-4,5-diacetoxyimidazoline, tetraacetylglycoluril, tetrapropionylglycoluril, diacylated 2,5-diketopiperazines, e.g., 1,4-diacetyl-2,5-diketopiperazine, acylation products of propylenediurea and 2,2-dimethylpropylenediurea, e.g., tetraacetylpropylenediurea, a-acyloxypolyacylmalonamides, e.g., a-acetoxy-N,N′-diacetylmalonamide, diacyldioxohexahydro-1,3,5-triazines, e.g., 1,5-diacetyl-2,4-dioxohexahydro-1,3,5-triazine, benz(4H)-1,3-oxazin-4-ones with alkyl radicals, e.g., methyl, or aromatic radicals, and combinations thereof. The bleach may also be combined with a bleach catalyst. The bleach catalyst may include, but is not limited to, quaternized imines, sulfonimines, manganese complexes, and combinations thereof. The bleach catalyst may be present in the builder and/or detergent compositions in any amount. In one embodiment, the bleach catalyst is present in the builder and/or detergent compositions in an amount of up to 1.5% by weight.

The additive may be an enzyme, as introduced above. The enzyme may include, but is not limited to, proteases such as Savinase® and Esperase®, lipases such as Lipolase®, cellulases such as Celluzym, and combinations thereof. Each of the Savinase®, Esperase®, Lipolase®, and Celluzym are commercially available from Novo Nordisk of Princeton, N.J. The enzyme may alternatively include an amylase, a lipase, a cellulase, or a peroxidase, or combinations thereof. The enzyme may break down soils, break down proteins into smaller and less complex molecules, and/or break down carbohydrates. In one embodiment, the (A) chelating component has excellent compatibility with the enzyme, which increases performance of the builder and/or detergent compositions. Additional non-limiting examples of suitable enzymes are commercially available from Danisco A/S of Copenhagen, Denmark, under the trade name PROPERASE®, such as PROPERASE® L, and under the trade name PURASTAR®, such as PURASTAR® HP Am. The enzyme may be present in the builder and/or detergent compositions in any amount. In one embodiment, the enzyme is present in the builder and/or detergent compositions in an amount of from 0.1 to 4% by weight. In other embodiments, the enzyme is present in the builder and/or detergent compositions in amounts of from about 0.1 to about 3, more typically from about 0.5 to about 2, and even more typically about 1, parts by weight, each based on 100 parts by weight of the builder and/or detergent compositions.

The additive may be a corrosion inhibitor. Suitable non-limiting corrosion inhibitors include sodium silicates. These inhibitors can provide protection of washer metal parts by acting as a lubricant and can provide protection for china patterns and metal tableware/utensils. Another example of a suitable corrosion inhibitor is zinc sulfate. Examples of suitable supplemental corrosion inhibitors are commercially available from BASF Corporation and Fisher Scientific of Pittsburgh, Pa. In various embodiments, the builder and/or detergent compositions include a corrosion inhibitor in amounts of from about 1 to about 40, of from about 1 to about 20, or up to about 10, parts by weight, each based on 100 parts by weight of the builder and/or detergent compositions. It is to be appreciated that the builder and/or detergent compositions may include a combination of two or more corrosion inhibitors.

The additive may be a filler, such as sodium sulfate. The filler typically provides stability or desirable physical properties to the builder and/or detergent compositions without necessarily impacting cleaning performance of the builder and/or detergent compositions. Examples of suitable fillers are commercially available from BASF Corporation. It is to be appreciated that water can be a filler. In various embodiments, the filler is present in the builder and/or detergent compositions in an amount of from about 10 to about 90, of from about 40 to about 80, or in about 70, parts by weight, each based on 100 parts by weight of the builder and/or detergent compositions. It is to be appreciated that the builder and/or detergent compositions may include a combination of two or more fillers.

The pH of the builder and/or detergent compositions can be of various numerical values. In various embodiments, the pH of the builder and/or detergent compositions is no greater than 13, 12, 11, 10, 9, 8, 7, 6, or 5. In alternative embodiments, the pH of the builder and/or detergent compositions is greater than 5, 6, 7, 8, 9, 10, 11, or 12. In one embodiment, the pH of the builder and/or detergent compositions ranges from about 7 to about 9. In another embodiment, the pH of the builder and/or detergent compositions is about 8. The pH of the builder and/or detergent compositions can be adjusted by the addition of acidic or basic components. Typically, too high of a pH can impact enzymes that may be present in the builder and/or detergent compositions.

In one embodiment, the additive is a soil release polymer. Suitable soil release polymers include, but are not limited to, amphiphilic graft polymers or copolymers of vinyl esters and/or acrylic esters onto polyalkylene oxides or modified celluloses, such as methylcellulose, hydroxypropylcellulose, and carboxymethylcellulose, and combinations thereof. Alternatively, the additive may be a suds/foam inhibitors including, but are not limited to, organopolysiloxanes, silica, paraffins, waxes, microcrystalline waxes, and combinations thereof. The soil release polymer may be present in the builder and/or detergent compositions in any amount.

In various embodiments, the additive is a supplemental builder component. Particularly suitable non-limiting supplemental builder components builders include both inorganic and organic builders. In one embodiment, the inorganic builders include crystalline and/or amorphous alumosilicates with ion-exchanging properties, such as zeolites. Various types of zeolites may be used including, but not limited to, A, X, B, P, MAP and HS zeolites in sodium form or in forms in which sodium is partially exchanged for lithium, potassium, calcium, magnesium, and/or ammonium. In another embodiment, the inorganic builders include carbonates and hydrogencarbonates as alkali metal salts, alkaline earth metal salts, and/or ammonium salts. Alternatively, the inorganic builder may include polyphosphates such as pentasodium triphosphate. The inorganic builder may include di-silicates and/or sheet silicates that may include ammonium silicates. One or more inorganic builders may be present in the builder and/or detergent compositions in any amount or any ratio. In one embodiment, the inorganic builder includes a mixture of alumosilicates and carbonates in a weight ratio of 98:2 to 20:80 and more typically of 85:15 to 40:60.

In one embodiment, the organic builder includes an acid selected from the group of carboxylic acids, copolymers of carboxylic acids, terpolymers of carboxylic acids, graft polymers of carboxylic acids, polyglyoxylic acids, polyamidocarboxylic acids, phosphonic acids, and combinations thereof. Particularly suitable carboxylic acids include C₄-C₂₀ di-, tri- and tetra-carboxylic acids such as succinic acid, propanetricarboxylic acid, butanetetracarboxylic acid, and cyclopentanetetracarboxylic acid, C₄-C₂₀ hydroxycarboxylic acids such as malic acid, tartaric acid, gluconic acid, glutaric acid, citric acid, and lactobionic acid, sucrose mono-, di- and tricarboxylic acids, alkyl- and alkenyl-succinic acids having C₂-C₁₆ alkyl and/or alkenyl radicals, aminopolycarboxylic acids such as nitrilotriacetic acid, 3-alaninediacetic acid, ethylenediaminetetraacetic acid, serinediacetic acid, isoserinediacetic acid, methylglycinediacetic acid and alkylethylenediamine triacetates, oligomaleic acids, co- and terpolymers of unsaturated C₄-C₈ dicarboxylic acids such as maleic acid, fumaric acid, itaconic acid and citraconic acid, monoethylenically unsaturated C₃-C₈ monocarboxylic acids such as acrylic acid, methacrylic acid, crotonic acid and vinylacetic acid, and combinations thereof.

Examples of suitable copolymers of dicarboxylic acids include, but are not limited to, copolymers of maleic acid with C₂-C₈ olefins in a molar ratio 40:60 to 80:20. A non-limiting example of a suitable terpolymer of the carboxylic acids includes a terpolymer of maleic acid, acrylic acid and a vinyl ester of a C₁-C₃ carboxylic acid in a weight ratio of 10 (maleic acid):90 (acrylic acid+vinyl ester): 95 (maleic acid):10 (acrylic acid+vinyl ester), where the weight ratio of acrylic acid to the vinyl ester can be from 30:70 to 70:30.

Suitable examples of graft polymers of carboxylic acids include a graft base and an unsaturated carboxylic acid. The carboxylic acid may include, but is not limited to, maleic acid, fumaric acid, itaconic acid, citraconic acid, acrylic acid, methacrylic acid, crotonic acid vinylacetic acid, and combinations thereof. Suitable graft bases included in the graft polymers of the carboxylic acids include degraded polysaccharides such as acidically and/or enzymatically degraded starches, inulins, cellulose, protein hydrolysates, reduced degraded polysaccharides such as mannitol, sorbitol, aminosorbitol and N-alkylglucamine, alkylene oxide block copolymers such as ethylene oxide/propylene oxide block copolymers, ethylene oxide/butylene oxide block copolymers, ethylene oxide/propylene oxide/butylene oxide block copolymers, and alkoxylated mono- or polyhydric C₁-C₇ alcohols and/or C₁₅-C₂₂ alcohols that are different from the first and second surfactants. In one embodiment, 20 to 80 parts by weight of the carboxylic acid per 100 parts by weight of the graft base, may be polymerized. In this embodiment, a mixture of maleic acid and acrylic acid in the weight ratio from 90:10 to 10:90 is typically polymerized with the graft base.

Additionally, the organic builder may include a polyaspartic acid or a co-condensate of aspartic acid with one or more amino acids including, but not limited to, C₄-C₂₅ mono- or di-carboxylic acids and/or C₄-C₂₅ mono- or di-amines. In one embodiment, the co-condensate includes a polyaspartic acid modified with C₆-C₂₂ mono- or di-carboxylic acids or with C₆-C₂₂ mono- or di-amines in acids including phosphorous.

Further, the organic builder may include a condensation product of citric acid and a hydroxycarboxylic acid or a polyhydroxy compound. Most typically, the condensation products of citric acid include carboxyl groups and have number average molecular weights of up to 10,000 g/mol. Still further, the organic builder may include ethylenediaminedisuccinic acid, oxydisuccinic acid, aminopolycarboxylates, aminopolyalkylene phosphonates, polyglutamates, and combinations thereof. Also, a non-limiting example of a suitable phosphonic acid includes hydroxyethanediphosphonic acid.

Alternatively, the organic builder may be selected from the group of olefins, ethers, esters, amines, oxidized starches, and combinations thereof. Suitable olefins, ethers, esters, and amines include, but are not limited to, monoethylenically unsaturated C₂-C₂₂ olefins, vinyl alkyl ethers with C₁-C₈ alkyl groups, styrene, vinyl esters of C₁-C₈ carboxylic acids, (meth)acrylamide and vinylpyrrolidone, (meth)acrylic esters of C₁-C₈ alcohols, (meth)acrylonitrile, (meth)acrylamides of C₁-C₈ amines, N-vinylformamide and vinylimidazole. In one embodiment, the organic builder is present in the builder and/or detergent compositions in an amount of from 0.1 to 20% by weight.

The additive may also be a copolymer of acrylic acid and 2-acrylamido-2-methylpropane sulfonate commercially available from BASF Corporation under the trade name of Sokalan® CP 50. In various embodiments, the sulfonate is present in the builder composition in an amount of from 0 to 20, 5 to 15, or 10 to 15, parts by weight per 100 parts by weight of the builder composition. Of course, the instant invention is not limited to these amounts.

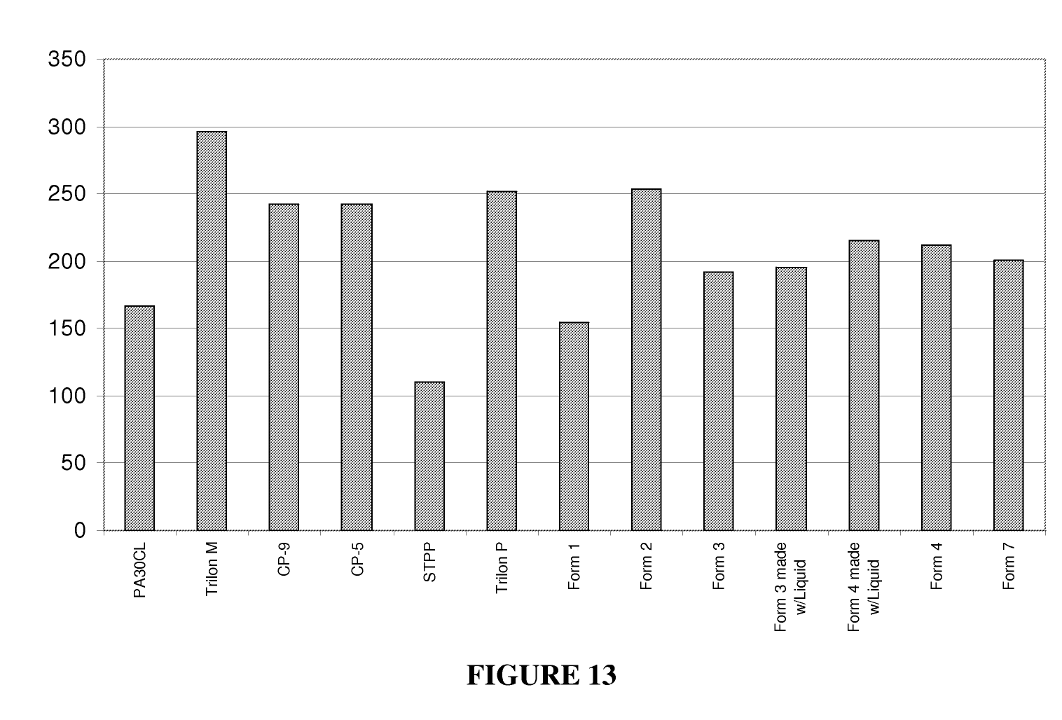

The builder and/or detergent compositions may also be evaluated relative to scale inhibition. In various embodiments, the builder and/or detergent compositions have a calcium carbonate (scale) dispersant capacity of from 50 to 300, 50 to 200, 50 to 100, 150 to 250, or 200 to 300, mg CaCO₃/g of the builder and/or detergent compositions. Typically, 1 gram of the builder composition is dissolved in 100 ml of deionized water in a beaker. Then, about 10 ml of 10% Na₂CO₃ solution is added to the beaker and the pH is adjusted to 11 with NaOH solution. The Na₂CO₃ solution including the builder composition is then titrated against 0.1 Mol/L Calcium Acetate solution until a start of turbidity is observed. The following equation is used to convert the data to mg CaCO₃/g builder: Calcium Acetate (Mol/L)×ml Calcium Acetate X 100.09. Results are set forth in FIG. 13 and explained in further detail below in the Examples section.

Additional non-limiting and non-required additives and/or components of the builder and/or detergent compositions of this invention are described in U.S. Pat. Nos. 7,504,373 and 7,503,333, and U.S. Provisional Patent Application No. 61/302,785 and a concurrently filed PCT Application, both related to Docket Number: 10062/PF-61435 and entitled “LIQUID DETERGENT COMPOSITION.” The disclosures of each of these documents are expressly incorporated by reference in their entirety to the extent that the disclosures do not conflict with the general scope of the present invention described herein.

### Method of Forming the Builder and Detergent Compositions:

As first introduced above, the instant invention also provides a method of forming the builder and detergent compositions. The method of forming the builder composition typically includes the step of introducing each of the (A) chelating component, (B) builder component, (C) polymeric component, and optionally said (D) alkali component and/or said (E) phosphorous-containing component into a vessel. Each of these components can be introduced independently or in combination with one or more of the other components. Additional components, such as the additives described above, can also be added. In one embodiment, each of the components is added to a blender and then mixed until a homogenous solution is obtained. Various vessels, mixers, blenders, and similar machinery known in the art can also be employed. Temperature and/or pressure can be adjusted to facilitate blending of the components. It is also contemplated that the detergent composition can be formed using the same, similar, or different method steps. It is to be appreciated that the present invention is not limited to any particular method of manufacturing. Conventional methods and apparatuses can be employed.

Method of Applying the Builder and/or Detergent Compositions to a Surface:

As also introduced above, this invention provides a method of applying the builder and/or detergent compositions to a surface. Typically, the method is further defined as washing/laundering/cleaning/sanitizing and/or disinfecting surfaces using the builder and/or detergent compositions. In one embodiment, the method includes the step of applying the builder and/or detergent compositions to the surface. The step of applying the builder and/or detergent compositions to the surface may be undertaken by any method known in the art. It is contemplated that the step of applying the builder and/or detergent compositions to the surface may be further defined as exposing the surface to the builder and/or detergent compositions.

Method of Applying the Builder and/or Detergent Compositions to a Textile:

If the surface is a textile, the step of applying the builder and/or detergent compositions may be further defined as flushing the textile with the builder and/or detergent compositions. Steps associated with applying the builder and/or detergent compositions to textiles are described in U.S. Pat. No. 7,503,333, the disclosure of which is expressly incorporated herein by reference in its entirety to the extent that the disclosure does not conflict with the general scope of the present invention described herein.

### EXAMPLES

The efficacy of various builder compositions of this invention are evaluated to determine cleaning efficiency. The results of these evaluations are summarized in the formulas described above and set forth in greater detail in the Figures.

### Fabric/Laundry Applications:

Different stains are applied to various fabrics as described above. Subsequently, various builder compositions are applied to the stained fabrics to determine their efficiency in removing the stains. This efficiency is referred to as “Percent Clean.” The Percent Clean is calculated using reflectance measurements of the fabrics. Reflectance measurements of the fabrics are taken in three conditions, “Before Soiling”, “After Soiling”, and “After Cleaning”. These measurements are determined using a reflectometer commercially available from X-Rite Asia Pacific Ltd. under the trade name of Colormaster. The reflectometer records three values based on the Hunter Color Scale. In the Hunter Color Scale, “L” values represent light (100) to dark (0), “a” values represent red (+a) to green (−a), and “b” values represent yellow (+b) to blue (−b). These three measurements are used to calculate ΔE via the following formula:

ΔE=((L_{AS}−L_{AC})²+(a_{AS}−a_{AC})²+(b_{AS}−b_{AC})²)^{1/2}

wherein AS represents the “After Soiling” condition and AC represents the “After Cleaning” condition. Subsequently, ΔE is used to calculate Percent Clean via the following formula:

Percent Clean=[(ΔE(AC−AS))÷(ΔE(BS−AS))]×100

wherein AS and AC are defined as above and BS represents the “Before Soiling” condition.

Initially, the reflectance of the fabrics “Before Soiling” is determined Subsequently, the fabrics are soiled with the various stains. The fabrics are then washed in a tergotometer for 10 minutes under different heating conditions (120° F. or 150° F.) according to ASTM D3050-05. Subsequently, the fabrics are then rinsed for one minute with different tap water (150 or 250 ppm of 2:1Ca/Mg). The tergotometer is commercially available from United States Testing Company of Hoboken, N.J. After washing, the fabrics are allowed to dry. After drying, the “After Cleaning” reflectance of each of the fabrics is determined. Upon determination of the “Before Soiling”, “After Soiling”, and “After Cleaning” reflectance values for the fabrics, the average “Percent Clean” measurements are calculated, as set forth in the Figures. Higher mean percent clean measurements indicate greater degrees of cleaning efficacy.

### Ceramic/Warewash Applications:

Different stains are applied to various ceramic surfaces as described above.

As described above relative to the first non-limiting equation, an egg is scrambled and approximately 1 gram of the scrambled egg is brushed onto a glazed ceramic saucer. The saucer is then placed in a convection oven at 187° C. for 30 min The saucer is then allowed to cool to room temperature before use. Subsequently, the builder composition is applied to remove the baked on egg stain and the saucer is washed in a Hobart AM-14 commercial dishwasher using a method described in greater detail below. The saucers are then visually evaluated for cleanliness. A clean saucer would have a rating of 0 and the baked saucers would have a rating of 5. Of course, the instant invention is not limited to use with egg stains as any protein stain may be substituted.

As described above relative to the second non-limiting equation, 110 g of H₂O is heated to a boil. The heat is then shut down and 10 g of ground Quaker oatmeal is added to the water and allowed to mix for 5 minutes. Subsequently, 1 g of powdered gravy is added to the oatmeal to form a solution. The solution is then allowed to cool to room temperature. Then, approximately 1 gram of the solution is brushed onto a glazed ceramic saucer. The saucer is then placed in a convection oven at 187° C. for 30 min The saucer is then allowed to cool to room temperature before use. Subsequently, the builder composition is applied to remove the oatmeal gravy and the saucer is washed in a Hobart AM-14 commercial dishwasher using a method described in greater detail below The saucers are then visually evaluated for cleanliness. A clean saucer would have a rating of 0 and the baked saucers would have a rating of 5. Of course, the instant invention is not limited to use with oatmeal stains as any carbohydrate stain may be substituted.

More specifically, in order to clean the stained saucers, a Hobart AM-14 Dishwasher is rinsed with water at 150° F. (±3° F.) and then drained. Samples of the various builder compositions are then individually added during the fill cycle (150° F. (±3° F.)) at a concentration of about 1700 ppm. Then a single saucer with the baked on egg and a single saucer with the baked on oatmeal gravy is placed on a rack in the dishwasher. The “manual wash” 1.5 minute setting is then selected. After 1.5 minutes, the rack is rotated 180 degrees. The “manual wash” 1.5 minute setting is then reselected. After an additional 1.5 minutes, the Dishwasher is shutdown. Subsequent to shutdown, the saucers are removed and allowed to air dry prior to visual evaluation to determine cleanliness. The results of the aforementioned evaluations are illustrated in the Figures.

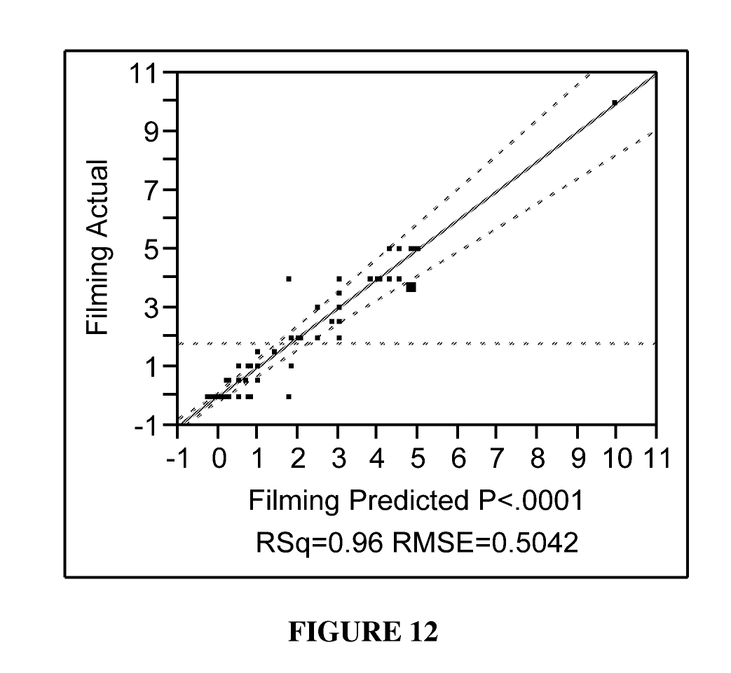

At the same time, a glass beaker is also loaded in the rack in the dishwasher. After the aforementioned washings, the glass beaker is visually evaluated to determine filming reduction performance (F), as described above in Non-Limiting Equation Three. The results of this evaluation are illustrated in FIG. 12.

### Hard-Surface Applications:

An oil/iron oxide stain mixture formed according to Federal Standard Test Method #536 is applied to various 4×6 inch vinyl tiles as described above. Then, samples of various formulations including the builder compositions of this invention are diluted to 3 wt % in hard water (250 ppm Ca/Mg 2/1) to form diluted compositions. The diluted compositions are then applied to the stain tiles according to Federal Standard Test Method #536 to determine percent clean.

More specifically, an X-rite reflectometer is used to determine an amount of the stain removed. This is done in a manner similar to that described above relative to fabric and laundry application. A Percent Clean is calculated using reflectance measurements of the vinyl tiles. Reflectance measurements of the vinyl tiles are taken in three conditions, “Before Soiling”, “After Soiling”, and “After Cleaning”. These measurements are determined using a reflectometer commercially available from X-Rite Asia Pacific Ltd. under the trade name of Colormaster. The reflectometer records three values based on the Hunter Color Scale. In the Hunter Color Scale, “L” values represent light(100) to dark (O), “a” values represent red (+a) to green (−a), and “b” values represent yellow (+b) to blue (−b). These three measurements are used to calculate ΔE via the following formula:

ΔE=((L_{AS}−L_{AC})²+(a_{AS}−a_{AC})²+(b_{AS}−b_{AC})²)^{1/2}

wherein AS represents the “After Soiling” condition and AC represents the “After Cleaning” condition. Subsequently, ΔE is used to calculate Percent Clean via the following formula:

Percent Clean=[(ΔE(AC−AS))÷(ΔE(BS−AS))]×100

wherein AS and AC are defined as above and BS represents the “Before Soiling” condition.
The results of the aforementioned evaluations are illustrated in the Figures.

Referring to FIG. 13, a bar graph illustrates CaCO₃ dispersant capacity (mg/g) as a function of Builder Composition of various embodiments of this invention. This test is a general indication of the water conditioning ability of the compositions. Higher values generally indicate a stronger ability to inhibit Calcium and Magnesium carbonate or scale formation. In the graph, various compositions are shown, including formulas (“Form”) 1 thorough 5 and 7. The formulas are shown below in Table 1.

TABLE 1

| | Example (Formula) | | | | | |
|---|---|---|---|---|---|---|
| | 1 | 2 | 3 | 4 | 5 | 7 |
| Sodium | 58.00 | 33.40 | 47.80 | 41.45 | 43.00 | 41.45 |
| Silicate (5H₂0) | | | | | | |
| CP-5 | 38.00 | 54.00 | 46.35 | 45.95 | 0.00 | 0.00 |
| CP-9 | 0.00 | 0.00 | 0.00 | 0.00 | 28.10 | 45.95 |
| Trilon M | 4.00 | 12.60 | 5.85 | 12.60 | 28.90 | 12.60 |
| Total | 100.00 | 100.00 | 100.00 | 100.00 | 100.00 | 100.00 |

PA30CL is SOKALAN® PA 30 CL, a polyacrylic acid (sodium salt), commercially available from BASF Corporation.

TRILON® M and TRILON® P are chelating agents commercially available from BASF Corporation.

CP-5 and CP-9 are SOKALAN® CP-5 and SOKALAN® CP-9, polycarboxylate copolymers, commercially available from BASF Corporation.

STPP is sodium tripolyphosphate.

The data described above, and illustrated in the Figures, makes clear that there is synergy between various components (A) through (E) and that amounts of these components can be optimized and customized to maximize cleaning efficiency relative to specific stains and specific surfaces.

It is to be understood that the appended claims are not limited to express and particular compounds, compositions, or methods described in the detailed description, which may vary between particular embodiments which fall within the scope of the appended claims. With respect to any Markush groups relied upon herein for describing particular features or aspects of various embodiments, it is to be appreciated that different, special, and/or unexpected results may be obtained from each member of the respective Markush group independent from all other Markush members. Each member of a Markush group may be relied upon individually and or in combination and provides adequate support for specific embodiments within the scope of the appended claims.

It is also to be understood that any ranges and subranges relied upon in describing various embodiments of the present invention independently and collectively fall within the scope of the appended claims, and are understood to describe and contemplate all ranges including whole and/or fractional values therein, even if such values are not expressly written herein. One of skill in the art readily recognizes that the enumerated ranges and subranges sufficiently describe and enable various embodiments of the present invention, and such ranges and subranges may be further delineated into relevant halves, thirds, quarters, fifths, and so on. As just one example, a range “of from 0.1 to 0.9” may be further delineated into a lower third, i.e., from 0.1 to 0.3, a middle third, i.e., from 0.4 to 0.6, and an upper third, i.e., from 0.7 to 0.9, which individually and collectively are within the scope of the appended claims, and may be relied upon individually and/or collectively and provide adequate support for specific embodiments within the scope of the appended claims. In addition, with respect to the language which defines or modifies a range, such as “at least,” “greater than,” “less than,” “no more than,” and the like, it is to be understood that such language includes subranges and/or an upper or lower limit As another example, a range of “at least 10” inherently includes a subrange of from at least 10 to 35, a subrange of from at least 10 to 25, a subrange of from 25 to 35, and so on, and each subrange may be relied upon individually and/or collectively and provides adequate support for specific embodiments within the scope of the appended claims. Finally, an individual number within a disclosed range may be relied upon and provides adequate support for specific embodiments within the scope of the appended claims. For example, a range “of from 1 to 9” includes various individual integers, such as 3, as well as individual numbers including a decimal point (or fraction), such as 4.1, which may be relied upon and provide adequate support for specific embodiments within the scope of the appended claims.

The present invention has been described herein in an illustrative manner, and it is to be understood that the terminology which has been used is intended to be in the nature of words of description rather than of limitation. Many modifications and variations of the present invention are possible in light of the above teachings.

The invention may be practiced otherwise than as specifically described within the scope of the appended claims.

1. A builder composition comprising:
A) a chelating component comprising
a1) methylglycine-N-N-diacetic acid (MGDA) and/or an alkali salt thereof, and/or
a2) N,N-bis(carboxymethyl)-L-glutamate (GLDA) and/or an alkali salt thereof, and/or
a3) ethylenediaminetetraacetic acid (EDTA) and/or an alkali salt thereof;
B) a builder component comprising
b1) a metal silicate, and/or
b2) a metal carbonate, and/or
b3) a metal citrate;
C) a polymeric component comprising
c1) an acrylic-maleic copolymer, and/or
c2) polyacrylic acid (PAA); and
D) optionally, an alkali component; and
E) optionally, a phosphorus-containing component;
wherein at least one the following conditions P and Z is true,
$$\begin{matrix}P = ( 5 * b 1 ) + ( 4.5 * D ) + ( 4.99 * E ) + ( 4.99 * b 2 ) + ( 4.99 * a 1 ) + ( 4.67 * a 2 ) + ( 5.04 * b 3 ) + ( 5.04 * c 1 ) + ( 5.04 * c 2 ) + ( 4.86 * a 3 ) + [ - 4.97 * ( b 1 * E ) ] + [ - 0.97 * ( b 1 * b 2 ) ] + [ - 8.97 * ( b 1 * a 1 ) ] + [ - 8.35 * ( b 1 * a 2 ) ] + [ - 1.08 * ( b 1 * b 3 ) ] + [ - 3.08 * ( b 1 * c 1 ) ] + [ - 4.08 * ( b 1 * c 2 ) ] + [ - 7.72 * ( b 1 * a 3 ) ] + [ - 16.97 * ( D * E ) ] + [ - 8.97 * ( D * b 2 ) ] + [ - 15.97 * ( D * a 1 ) ] + [ - 13.35 * ( D * a 2 ) ] + [ - 5.08 * ( D * b 3 ) ] + [ - 8.08 * ( D * c 1 ) ] + [ - 6.08 * ( D * c 2 ) ] + [ - 13.72 * ( D * a 3 ) ] + [ - 1.95 * ( E * b 2 ) ] + [ - 1.95 * ( b 2 * a 1 ) ] + [ - 3.32 * ( b 2 * a 2 ) ] + [ - 2.06 * ( b 2 * c 2 ) ] + [ \begin{matrix}- 1.70 * \\ ( b 2 * a 3 )\end{matrix} ] + [ \begin{matrix}- 1.32 * \\ ( a 1 * a 2 )\end{matrix} ] + [ \begin{matrix}- 1.70 * \\ ( a 1 * a 3 )\end{matrix} ] + [ 0.93 * ( a 2 * a 3 ) ] , and \text{/} or & \\ Z = ( 4.75 * b 1 ) + ( 4 * D ) + ( 4.85 * E ) + ( 4.54 * b 2 ) + ( 4.83 * a 1 ) + ( 4.30 * a 2 ) + ( 4.94 * b 3 ) + ( 4.38 * c 1 ) + ( 4.36 * c 2 ) + ( 4.65 * a 3 ) + [ \begin{matrix}- 2.5 * \\ ( b 1 * D )\end{matrix} ] + [ \begin{matrix}- 5.2 * \\ ( b 1 * E )\end{matrix} ] + [ \begin{matrix}- 2.57 * \\ ( b 1 * b 2 )\end{matrix} ] + [ \begin{matrix}- 3.14 * \\ ( b 1 * a 2 )\end{matrix} ] + [ \begin{matrix}- 4.38 * \\ ( b 1 * b 3 )\end{matrix} ] + [ \begin{matrix}- 2.26 * \\ ( b 1 * c 1 )\end{matrix} ] + [ \begin{matrix}- 8.23 * \\ ( b 1 * c 2 )\end{matrix} ] + [ \begin{matrix}- 5.82 * \\ ( b 1 * a 3 )\end{matrix} ] + [ \begin{matrix}- 15.71 * \\ ( D * E )\end{matrix} ] + [ \begin{matrix}- 14.08 * \\ ( D * b 2 )\end{matrix} ] + [ \begin{matrix}- 17.25 * \\ ( D * a 1 )\end{matrix} ] + [ \begin{matrix}- 17.25 * \\ ( D * a 1 )\end{matrix} ] + [ \begin{matrix}- 14.59 * \\ ( D * a 2 )\end{matrix} ] + [ \begin{matrix}- 7.88 * \\ ( D * b 3 )\end{matrix} ] + [ \begin{matrix}- 11.76 * \\ ( D * c 1 )\end{matrix} ] + [ \begin{matrix}- 9.73 * \\ ( D * c 2 )\end{matrix} ] + [ \begin{matrix}- 13.31 * \\ ( D * a 3 )\end{matrix} ] + [ \begin{matrix}- 1.78 * \\ ( E * b 2 )\end{matrix} ] + [ \begin{matrix}- 2.67 * \\ ( b 2 * a 2 )\end{matrix} ] + [ \begin{matrix}- 3.24 * \\ ( a 1 * a 2 )\end{matrix} ] + [ \begin{matrix}- 1.97 * \\ ( a 1 * a 3 )\end{matrix} ] + [ \begin{matrix}- 1.47 * \\ ( a 2 * b 3 )\end{matrix} ] + [ \begin{matrix}- 1.36 * \\ ( a 2 * c 1 )\end{matrix} ] + [ - 5.91 * ( a 2 * a 3 ) ] ; & \end{matrix}$$
wherein
i) 0<P≦3.5,
ii) 0<Z≦3.5,
iii) at least one of a1, a2, and a3 is greater than zero and less than 1.0,
iv) at least one of b1, b2, and b3 is greater than zero and less than 1.0,
v) at least one of c1 and c2 is greater than zero and less than 1.0,
vi) D ranges from zero to less than 1.0,
vii) E ranges from zero to less than 1.0, and
viii) a1+a2+a3+b1+b2+b3+c1+c2+D+E=1.0;
wherein P is protein removal performance of said builder composition on a ceramic substrate, Z is carbohydrate removal performance of said builder composition on a ceramic substrate, a1 is the weight fraction of said chelating component a1), a2 is the weight fraction of said chelating component a2), a3 is the weight fraction of said chelating component a3), b1 is the weight fraction of said metal silicate b1), b2 is the weight fraction of said metal carbonate b2), b3 is the weight fraction of said metal citrate b3), c1 is the weight fraction of said acrylic-maleic copolymer c1), c2 is the weight fraction of said PAA c2), D is the weight fraction of optional alkali component D), and E is the weight fraction of optional phosphorus-containing component E); and
wherein the weight fractions are based on the total amount of said chelating component A), builder component B), polymeric component C), and optionally said alkali component D) and said phosphorous-containing component E) present in said builder composition.

2. A builder composition as set forth in claim 1 wherein the following condition F is also true:
$$F = ( 3.28 * b 1 ) + ( 9.91 * D ) + ( 1.74 * E ) + ( 4.26 * b 2 ) + ( - 0.08 * a 1 ) + ( 0.09 * a 2 ) + ( - 0.17 * b 3 ) + ( 1.39 * c 1 ) + ( 0.18 * c 2 ) + ( - 0.26 * a 3 ) + [ - 9.45 * ( b 1 * D ) ] + [ - 11.12 * ( b 1 * E ) ] + [ - 6.47 * ( b 1 * a 1 ) ] + [ - 3.81 * ( b 1 * a 2 ) ] + [ - 6.42 * ( b 1 * c 1 ) ] + [ - 3.12 * ( b 1 * a 3 ) ] + [ - 19.29 * ( D * E ) ] + [ - 10.32 * ( D * b 2 ) ] + [ - 7.65 * ( D * a 1 ) ] + [ - 10.59 * ( D * c 1 ) ] + [ - 2.17 * ( D * c 2 ) ] + [ - 1.99 * ( E * b 2 ) ] + [ - 3.31 * ( E * a 1 ) ] + [ - 3.65 * ( E * a 2 ) ] + [ - 4.26 * ( E * c 1 ) ] + [ - 3.84 * ( E * c 2 ) ] + [ 3.32 * ( b 2 * a 2 ) ] + [ \begin{matrix}3.13 * \\ ( b 2 * c 2 )\end{matrix} ] + [ 8.01 * ( b 2 * a 3 ) ] + [ 10.69 * ( a 1 * a 3 ) ] + [ 12.35 * ( a 2 * a 3 ) ] + [ 5.56 * ( b 3 * c 1 ) ] + [ 2.87 * ( b 3 * a 3 ) ] + [ - 3.14 * ( c 1 * c 2 ) ] + [ - 2.26 * ( c 1 * a 3 ) ] ;$$
wherein F is filming reduction performance of said builder composition on a ceramic substrate, and
wherein 0<F≦3.5.

3. A builder composition as set forth in claim 1 wherein said chelating component A) includes Na₃.MGDA.

4. A builder composition as set forth in claim 3 wherein said chelating component A) is aqueous and said Na₃.MGDA is present in an amount of from about 35 to about 45 parts by weight based on 100 parts by weight of said chelating component A).

5. A builder composition as set forth in claim 4 wherein said builder component B) comprises said b1) metal silicate, said b2) metal carbonate, and said b3) metal citrate.

6. A builder composition as set forth in claim 1 wherein said A) chelating component comprises said a1) MGDA and is present in an amount of from 5 to 10 parts by weight per 100 parts by weight of said builder composition, said B) builder component is present in an amount of from 15 to 25 parts by weight per 100 parts by weight of said builder composition, and said C) polymeric component comprises said c1) acrylic-maleic copolymer and is present in an amount of from 30 to 35 parts by weight per 100 parts by weight of said builder composition, and wherein said builder composition further comprises said D) alkali component present in an amount of from 40 to 45 parts by weight per 100 parts by weight of said builder composition.

7. A builder composition comprising:
A) a chelating component comprising
a1) methylglycine-N-N-diacetic acid (MGDA) and/or an alkali salt thereof, and/or
a2) N,N-bis(carboxymethyl)-L-glutamate (GLDA) and/or an alkali salt thereof, and/or
a3) ethylenediaminetetraacetic acid (EDTA) and/or an alkali salt thereof;
B) a builder component comprising
b1) a metal silicate, and/or
b2) a metal carbonate, and/or
b3) a metal citrate;
C) a polymeric component comprising
c1) an acrylic-maleic copolymer, and/or
c2) polyacrylic acid (PAA); and
D) optionally, an alkali component; and
E) optionally, a phosphorus-containing component;
wherein the following condition S is true, using water having a hardness (H) of Ca²⁺ as CaCO₃ in parts per million in the water and having a temperature (T) in degrees Fahrenheit,
$$S = ( 206.59 * a 1 ) + ( 63.09 * b 1 ) + ( - 72.04 * D ) + ( 165.46 * E ) + ( 184.84 * c 1 ) + ( 69.54 * b 3 ) + ( 214.93 * a 2 ) + [ - 128.32 * ( a 1 * D ) ] + [ 316.97 * ( b 1 * D ) ] + [ 124.84 * ( b 1 * E ) ] + [ 172.47 * ( b 1 * c 1 ) ] + [ 118.04 * ( b 1 * a 2 ) ] + [ 643.71 * ( D * E ) ] + [ 622.44 * ( D * c 1 ) ] + [ \begin{matrix}- 447.42 * \\ ( D * b 1 )\end{matrix} ] + [ - 294.34 \underline{*} ( D * a 2 ) ] + [ \begin{matrix}- 131.51 * \\ ( E * c 1 )\end{matrix} ] + ( - 0.69 * H ) + ( 2.05 * T ) ;$$
wherein
i) 180≦S,
ii) at least one of a1, a2, and a3 is greater than zero and less than 1.0,
iii) at least one of b1, b2, and b3 is greater than zero and less than 1.0,
iv) at least one of c1 and c2 is greater than zero and less than 1.0,
v) D ranges from zero to less than 1.0,
vi) E ranges from zero to less than 1.0, and
vii) a1+a2+a3+b1+b2+b3+c1+c2+D+E=1.0;
wherein S is the stain removal performance of said builder composition on a fabric, a1 is the weight fraction of said chelating component a1), a2 is the weight fraction of said chelating component a2), a3 is the weight fraction of said chelating component a3), b1 is the weight fraction of said metal silicate b1), b2 is the weight fraction of said metal carbonate b2), b3 is the weight fraction of said metal citrate b3), c1 is the weight fraction of said acrylic-maleic copolymer c1), c2 is the weight fraction of said PAA c2), D is the weight fraction of optional alkali component D), and E is the weight fraction of optional phosphorus-containing component E); and
wherein the weight fractions are based on the total amount of said chelating component A), builder component B), polymeric component C), and optionally said alkali component D) and said phosphorous-containing component E) present in said builder composition.

8. A builder composition as set forth in claim 7 wherein the following condition M is also true:
$$M = ( - 0.15 * a 1 ) + ( - 28.74 * b 1 ) + ( - 38.02 * D ) + ( - 10.15 * E ) + ( - 10.22 * c 1 ) + ( - 26.79 * b 3 ) + ( 5.74 * a 2 ) + [ - 35.37 * ( a 1 * D ) ] + [ - 35.37 * ( a 1 * D ) ] + [ 14.11 * ( a 1 * a 2 ) ] + [ 14.95 * ( b 1 * D ) ] + [ 12.79 * ( b 1 * E ) ] + [ 21.08 * ( b 1 * c 1 ) ] + [ 39.04 * ( D * E ) ] + [ 36.17 * ( D * c 1 ) ] + [ - 50.71 * ( D * b 3 ) ] + [ \begin{matrix}- 72.59 * \\ ( D * a 2 )\end{matrix} ] + [ - 13.63 * ( E * c 1 ) ] + [ \begin{matrix}22.63 * \\ ( E * a 2 )\end{matrix} ] + ( - 0.10 * H ) + ( 0.36 * T ) ;$$
wherein M is the performance of said builder composition in removing dirty motor oil stains from a fabric comprising polyester and cotton, and
wherein M is at least 5.

9. A builder composition as set forth in claim 7 wherein the following condition O is also true:
$$O = ( - 2.81 * a 1 ) + ( - 9.19 * b 1 ) + ( - 27.12 * D ) + ( - 2.76 * E ) + ( 0.46 * c 1 ) + ( - 6.43 * b 3 ) + ( - 0.49 * a 2 ) + [ - 32.19 * ( a 1 * D ) ] + [ 21.69 * ( b 1 * D ) ] + [ 16.44 * ( D * E ) ] + [ 39.13 * ( D * c 1 ) ] + [ - 58.80 * ( D * b 3 ) ] + [ - 64.78 * ( D * a 2 ) ] + [ 11.51 * ( c 1 * b 3 ) ] + ( - 0.01 * H ) + ( 0.27 * T ) ;$$
wherein 0 is the performance of said builder composition in removing dirty motor oil stains from a fabric comprising cotton, and
wherein O is at least 15.

10. A builder composition as set forth in claim 7 wherein the following condition Y is also true:
$$Y = ( 25.92 * a 1 ) + ( - 0.61 * b 1 ) + ( - 5.71 * D ) + ( 18.02 * E ) + ( 22.77 * c 1 ) + ( - 1.99 * b 3 ) + ( 17.85 * a 2 ) + [ 31.53 * ( a 1 * D ) ] + [ - 14.90 * ( a 1 * E ) ] + [ - 13.43 * ( a 1 * c 1 ) ] + [ 38.64 * ( b 1 * D ) ] + [ 16.02 * ( b 1 * E ) ] + [ 28.29 * ( b 1 * c 1 ) ] + [ 26.86 * ( b 1 * a 2 ) ] + [ 109.19 * ( D * E ) ] + [ 71.73 * ( D * c 1 ) ] + [ 30.89 * ( D * b 3 ) ] + [ 46.29 * ( D * a 2 ) ] + [ - 29.99 * ( E * c 1 ) ] + [ - 19.91 * ( c 1 * a 2 ) ] + [ 26.32 * ( b 3 * a 2 ) ] + ( - 0.13 * H ) + ( 0.35 * T ) ;$$
wherein Y is the performance of said builder composition in removing stains comprising mineral oil and carbon black from a fabric comprising cotton, and
wherein Y is at least 15.

11. A builder composition as set forth in claim 7 wherein the following condition L is also true:
$$L = ( 5.65 * a 1 ) + ( - 16.06 * b 1 ) + ( - 24.74 * D ) + ( - 1.59 * E ) + ( - 3.98 * c 1 ) + ( - 13.83 * b 3 ) + ( 13.59 * a 2 ) + [ 18.30 * ( a 1 * D ) ] + [ - 11.83 * ( a 1 * E ) ] + [ - 11.31 * ( a 1 * c 1 ) ] + [ 34.54 * ( b 1 * D ) ] + [ 28.34 * ( b 1 * c 1 ) ] + [ - 14.13 * ( b 1 * b 3 ) ] + [ 100.72 * ( D * E ) ] + [ 104.74 * ( D * c 1 ) ] + [ - 42.48 * ( D * b 3 ) ] + [ - 26.48 * ( E * c 1 ) ] + [ - 17.59 * ( E * b 3 ) ] + [ 15.59 * ( c 1 * a 2 ) ] + [ \begin{matrix}- 16.49 * \\ ( b 3 * a 2 )\end{matrix} ] + ( - 0.09 * H ) + ( 0.45 * T ) ;$$
wherein L is the performance of said builder composition in removing lipstick stains from a fabric comprising cotton, and
wherein L is at least 30.

12. A builder composition as set forth in claim 7 wherein the following condition K is also true:
$$K = ( 52.42 * a 1 ) + ( 25.43 * b 1 ) + ( - 59.44 * D ) + ( 48.42 * E ) + ( 56.75 * c 1 ) + ( 41.43 * b 3 ) + ( 67.07 * a 2 ) + [ - 125.14 * ( a 1 * D ) ] + [ 27.50 * ( a 1 * E ) ] + [ 26.36 * ( a 1 * c 1 ) ] + [ 118.40 * ( b 1 * D ) ] + [ 55.11 * ( b 1 * E ) ] + [ 42.39 * ( b 1 * c 1 ) ] + [ 67.28 * ( b 1 * a 2 ) ] + [ 202.82 * ( D * E ) ] + [ 235.57 * ( D * c 1 ) ] + [ - 294.51 * ( D * b 3 ) ] + [ - 191.52 * ( D * a 2 ) ] + ( - 0.06 * H ) + ( 0.17 * T ) ;$$
wherein K is the performance of said builder composition in removing makeup stains from a fabric comprising cotton, and
wherein K is at least 10.

13. A builder composition as set forth in claim 7 wherein the following condition U is also true:
$$U = ( 79.12 * a 1 ) + ( 70.65 * b 1 ) + ( 57.54 * D ) + ( 72.74 * E ) + ( 73.71 * c 1 ) + ( 62.05 * b 3 ) + ( 73.48 * a 2 ) + [ - 9.10 * ( a 1 * D ) ] + [ - 10.87 * ( a 1 * E ) ] + [ - 9.61 * ( a 1 * a 2 ) ] + [ 36.14 * ( b 1 * D ) ] + [ 21.95 * ( b 1 * E ) ] + [ 22.45 * ( b 1 * c 1 ) ] + [ 73.88 * ( D * E ) ] + [ 60.85 * ( D * c 1 ) ] + [ - 41.41 * ( D * b 3 ) ] + [ - 41.50 * ( D * a 2 ) ] + [ - 21.80 * ( E * c 1 ) ] + ( - 0.12 * H ) + ( 0.14 * T ) ;$$
wherein U is the performance of said builder composition in removing sebum stains from a fabric comprising polyester and cotton, and
wherein U is at least 60.

14. A builder composition as set forth in claim 7 wherein the following condition Q is also true:
$$Q = ( 46.83 * a 1 ) + ( 17.91 * b 1 ) + ( 24.51 * D ) + ( 40.17 * E ) + ( 43.34 * c 1 ) + ( 13.71 * b 3 ) + ( 36.65 * a 2 ) + [ 15.82 * ( a 1 * b 1 ) ] + [ 22.98 * ( a 1 * D ) ] + [ - 14.75 * ( a 1 * E ) ] + [ - 19.07 * ( a 1 * a 2 ) ] + [ 57.30 * ( b 3 * D ) ] + [ 29.81 * ( b 3 * E ) ] + [ 42.79 * ( b 1 * c 1 ) ] + [ 28.85 * ( b 1 * a 2 ) ] + [ 102.43 * ( D * E ) ] + [ 79.99 * ( D * c 1 ) ] + [ 25.44 * ( D * a 2 ) ] + [ - 31.07 * ( E * c 1 ) ] + [ - 14.47 * ( c 1 * a 2 ) ] + [ 24.72 * ( b 3 * a 2 ) ] + ( - 0.19 * H ) + ( 0.33 * T ) ;$$
wherein Q is the performance of said builder composition in removing olive oil and carbon black from a fabric comprising cotton, and
wherein Q is at least 40.

15. A builder composition as set forth in claim 7 wherein said A) chelating component comprises said a1) MGDA and is present in an amount of from 10 to 15 parts by weight per 100 parts by weight of said builder composition, said B) builder component is present in an amount of from 30 to 35 parts by weight per 100 parts by weight of said builder composition, and said C) polymeric component comprises said c1) acrylic-maleic copolymer and is present in an amount of from 50 to 60 parts by weight per 100 parts by weight of said builder composition.

16. A builder composition comprising:
A) a chelating component comprising
a1) methylglycine-N-N-diacetic acid (MGDA) and/or an alkali salt thereof, and/or
a2) N,N-bis(carboxymethyl)-L-glutamate (GLDA) and/or an alkali salt thereof, and/or
a3) ethylenediaminetetraacetic acid (EDTA) and/or an alkali salt thereof;
B) a builder component comprising
b1) a metal silicate, and/or
b2) a metal carbonate, and/or
b3) a metal citrate;
C) a polymeric component comprising
c1) an acrylic-maleic copolymer, and/or
c2) polyacrylic acid (PAA); and
D) optionally, an alkali component; and
E) optionally, a phosphorus-containing component;
wherein the following condition X is true
$$X = ( 76.08 * E ) + ( 66.71 * D ) + ( 63.14 * b 1 ) + ( 74.86 * a 1 ) + ( 75.55 * b 3 ) + ( 71.46 * c 1 ) + ( 78.99 * a 3 ) + ( 78.26 * a 2 ) + [ 18.44 * ( E * D ) ] + [ 16.96 * ( E * b 1 ) ] + [ 28.24 * ( E * a 1 ) ] + [ - 13.31 * ( E * b 3 ) ] + [ 14.40 * ( E * a 3 ) ] + [ 28.95 * ( E * a 2 ) ] + [ 8.03 * ( D * a 1 ) ] + [ 38.6 \underline{*} ( D * c 1 ) ] + [ 18.62 * ( b 1 * a 1 ) ] + [ - 13.09 * ( b 1 * b 3 ) ] + [ 9.55 * ( b 1 * c 1 ) ] + [ - 11.28 * ( b 1 * a 3 ) ] + [ 19.40 * ( a 1 * c 1 ) ] + [ - 18.27 * ( a 1 * a 3 ) ] + [ - 23.22 * ( b 3 * c 1 ) ] + [ - 34.14 * ( b 3 * a 3 ) ] + [ - 22.77 * ( c 1 * a 3 ) ] ;$$
wherein
i) 65≦X,
ii) at least one of a1, a2, and a3 is greater than zero and less than 1.0,
iii) at least one of b1, b2, and b3 is greater than zero and less than 1.0,
iv) at least one of c1 and c2 is greater than zero and less than 1.0,
v) D ranges from zero to less than 1.0,
vi) E ranges from zero to less than 1.0, and
vii) a1+a2+a3+b1+b2+b3+c1+c2+D+E=1.0;
wherein X is the oil/iron oxide stain removal performance of said builder composition on vinyl tiles according to Federal Standard Test Method #536, a1 is the weight fraction of said chelating component a1), a2 is the weight fraction of said chelating component a2), a3 is the weight fraction of said chelating component a3), b1 is the weight fraction of said metal silicate b1), b2 is the weight fraction of said metal carbonate b2), b3 is the weight fraction of said metal citrate b3), c1 is the weight fraction of said acrylic-maleic copolymer c1), c2 is the weight fraction of said PAA c2), D is the weight fraction of optional alkali component D), and E is the weight fraction of optional phosphorus-containing component E); and
wherein the weight fractions are based on the total amount of said chelating component A), builder component B), polymeric component C), and optionally said alkali component D) and said phosphorous-containing component E) present in said builder composition.

17. A builder composition as set forth in claim 16 wherein said A) chelating component comprises said a1) MGDA and is present in an amount of from 5 to 20 parts by weight per 100 parts by weight of said builder composition, said B) builder component is present in an amount of from 30 to 60 parts by weight per 100 parts by weight of said builder composition, and said C) polymeric component comprises said c1) acrylic-maleic copolymer and is present in an amount of from 15 to 55 parts by weight per 100 parts by weight of said builder composition, and wherein said builder composition further comprises said D) alkali component present in an amount of from 1 to 45 parts by weight per 100 parts by weight of said builder composition.

18. A builder composition as set forth in claim 1 that includes less than 2 parts by weight of said phosphorus-containing component E) per 100 parts by weight of said builder composition.

19. A builder composition as set forth in claim 18 that is free of said phosphorus-containing component E).

20. A builder composition as set forth in claim 7 that includes less than 2 parts by weight of said phosphorus-containing component E) per 100 parts by weight of said builder composition.

21. A builder composition as set forth in claim 20 that is free of said phosphorus-containing component E).

22. A builder composition as set forth in claim 16 that includes less than 2 parts by weight of said phosphorus-containing component E) per 100 parts by weight of said builder composition.

23. A builder composition as set forth in claim 22 that is free of said phosphorus-containing component E).
